(19) United States
(12) Patent Application Publication
(10) Pub. No.: US 2025/0016598 A1
(43) Pub. Date: Jan. 9, 2025

(54) CONFIGURABLE GRANULARITY FOR MEASUREMENT AND REPORTING OF TRANSMISSION LATENCY IN A WIRELESS NETWORK

(71) Applicant: ZTE Corporation, Shenzhen (CN)

(72) Inventors: Zhuang LIU, Shenzhen (CN); Yin GAO, Shenzhen (CN); Yingjun ZHOU, Shenzhen (CN); Dapeng LI, Shenzhen (CN); Xiubin SHA, Shenzhen (CN)

(73) Assignee: ZTE Corporation, Shenzhen (CN)

(21) Appl. No.: 18/891,658

(22) Filed: Sep. 20, 2024

Related U.S. Application Data
(63) Continuation of application No. PCT/CN2022/108325, filed on Jul. 27, 2022.

(51) Int. Cl. H04W 24/10; H04W 24/08

(52) U.S. Cl. CPC H04W 24/10; H04W 24/08

(57) ABSTRACT

This disclosure is generally directed to wireless communication systems and methods and relates particularly to monitoring and reporting of uplink and downlink data transmission latency according to a configurable timing and data granularity. The various example implementations disclosed herein provide a mechanism for the network side of the wireless network system to flexibly configure the monitoring, measurement, calculation, and reporting of information related to downlink and uplink data transmission latency in a collaborative manner among the various network nodes, devices and entities, and between the control-plane and user-plane of the wireless network. The disclosed implementations provide a configurable network latency segmentation scheme in addition to configurable timing, data or data flow granularity, content, and format for the monitoring/measurement/calculation/reporting of relevant latency information. The various network devices or nodes are thus coordinated under the adaptive configuration by the network to efficiently monitor, measure, calculate, and report latency information adapted to the need of a particular application and particular data communication session. For the reporting latency information in the user-plane, a special-purpose Protocol Data Unit (PDU) is also designed and constructed.

### TECHNICAL FIELD

This disclosure is generally directed to wireless communication systems and methods and relates particularly to monitoring and reporting of uplink and downlink data transmission delay according to a configurable timing and data granularity.

### BACKGROUND

Data transmission between a wireless terminal and a core network in a wireless communication system may rely on both an over-the-air communication interface between the wireless terminal and a wireless access network node and one or more communication interfaces between the wireless access network node and the core network. End-to-end time delay or latency (these two terms are used interchangeably in this disclosure) for such data transmission constitutes a critical performance indicator of the wireless communication system, particular for Ultra Reliable Low Latency Communication (URLLC) applications. An effective monitoring and reporting of such end-to-end communication delay would facilitate diagnosis and improvement of wireless network transmission functions.

### SUMMARY

This disclosure is generally directed to wireless communication systems and methods and relates particularly to monitoring and reporting of uplink and downlink data transmission delay according to a configurable timing and data granularity. The various example implementations disclosed herein provide a mechanism for the network side of the wireless network system to flexibly configure the monitoring, measurement, calculation, and reporting of information related to downlink and uplink data transmission latency in a collaborative manner among the various network nodes, devices and entities, and between the control-plane and user-plane of the wireless network. The disclosed implementations provide a configurable network latency segmentation scheme in addition to configurable timing, data or data flow granularity, content, and format for the monitoring/measurement/calculation/reporting of relevant latency information. The various network devices or nodes are thus coordinated under the adaptive configuration by the network to efficiently monitor, measure, calculate, and report latency information adapted to the need of a particular application and particular data communication session. For the reporting latency information in the user-plane, a special-purpose Protocol Data Unit (PDU) is also designed and constructed.

In some example implementations, a method by a wireless access network node of a wireless network for provisioning a data transmission delay between a wireless terminal device and a core network is disclosed. The method may include receiving a transmission delay configuration from the core network, the transmission delay configuration specifying at least one of: a transmission delay provisioning segmentation scheme among a plurality of segmentation schemes; or a monitoring/reporting configuration for the data transmission delay among a plurality of monitoring/reporting configurations. The method may further include transmitting at least part of the transmission delay configuration to the wireless terminal device; receiving a transmission delay information item from the wireless terminal device during a data transmission session between the core network and the wireless terminal device; and generating and transmitting a report to the core network based on the transmission delay information item and according to the transmission delay configuration.

In the implementations above, the transmission delay provisioning segmentation scheme may include one of an end-to-end delay scheme or a Radio Access Network (RAN) part delay scheme.

In any of the implementations above, the monitoring/reporting configuration comprises at least one of a reporting timing configuration; a reporting granularity configuration; or a data packet transmission timestamp scheme.

In any of the implementations above the reporting timing configuration indicates a reporting frequency or reporting time period.

In any of the implementations above the reporting granularity configuration indicates reporting the data transmission delay as at least one of: an average data packet delay; a per-packet delay; a packet delay distribution; or a packet delay distribution formula information.

In any of the implementations above, the reporting granularity configuration indicates reporting the data transmission delay as the packet delay distribution; the packet delay distribution is included in an uplink protocol data unit (PDU) session frame; and the uplink PDU session frame comprises: a first field indicating a number of delay ranges; and a plurality of blocks of fields, each block of fields comprises a number of packets with latency values falling into one of the delay ranges.

In any of the implementations above the reporting granularity configuration indicates reporting the data transmission delay as the packet delay distribution formula information; the packet delay distribution formula information is included in an uplink protocol data unit (PDU) session frame; and the uplink PDU session frame comprises: a first field for identifying a packet delay distribution formula; a second field for indicating a number of parameters associated with the packet delay distribution formula; and a block of fields comprising values of the number of parameters.

In any of the implementations above the reporting granularity configuration indicates reporting the data transmission delay as the per-packet delay; the per-packet delay is included in an uplink protocol data unit (PDU) session frame; and the PDU session frame comprises: a first field indicating a number of per-packet delay samples; and a plurality of second fields each comprising a per-packet delay sample.

In any of the implementations above, the data packet transmission timestamp scheme indicates one of: including transmission time stamps in data packet headers; or including transmission timestamps in packet data converged protocol headers.

In any of the implementations above, the data transmission delay is associates with a user-plane of the wireless network.

In any of the implementations above, the data transmission delay comprises a downlink user-plane data transmission delay.

In any of the implementations above, the method further comprises relaying at least one downlink data packets from the core network to the wireless terminal device; and the transmission delay information item associated with the at least one downlink data packets is received from the wireless terminal device in a control-plane of the wireless access network node and comprises an end-to-end or RAN part downlink transmission delay information associated with the at least one downlink data packets as calculated by the wireless terminal device.

In any of the implementations above, the transmission delay information item is received in the control-plane of the wireless access network node as a part of a Radio Resource Control (RRC) measurement report.

In any of the implementations above, generating and transmitting the report to the core network comprises inserting the report in an NG Application Protocol (NGAP) message and transmitting the NGAP message to the core network in the control-plane.

In any of the implementations above, generating and transmitting the report to the core network comprises: inserting the report into an E1 Application Protocol (E1AP) message in the control-plane and transmitting the E1AP message to the user-plane of the wireless access network node; extracting the report from the E1AP message and inserting the report into a PDU session information PDU in the user-plane of the wireless access network node; and transmitting the PDU session information PDU to the core network in the user-plane.

In any of the implementations above, the data transmission delay comprises an uplink user-plane data transmission delay.

In any of the implementations above, the transmission delay information item received from the wireless terminal device comprises timestamp information for at least one uplink data packet transmitted from the wireless terminal device.

In any of the implementations above, the timestamp information for the at least one uplink data packet transmitted from the wireless terminal device is included in headers of the at least one uplink data packet.

In any of the implementations above, the transmission delay provisioning segmentation scheme comprises the end-to-end delay scheme; and generating and transmitting the report to the core network according to the transmission delay configuration comprises relaying the timestamp information to the core network for the core network to calculate the data transmission delay.

In any of the implementations above, the transmission delay provisioning segmentation scheme comprises the RAN part delay scheme; and generating and transmitting the report to the core network according to the transmission delay configuration comprises: calculating a RAN part delay information associated with the at least one uplink data packet in the user-plane of the wireless access network node; transmitting the RAN part delay information to a control-plane of the wireless access network node; and transmitting the RAN part delay information to the core network via an NGAP message in the control-plane.

In any of the implementations above the transmission delay provisioning segmentation scheme comprises the RAN part delay scheme; and generating and transmitting the report to the core network according to the transmission delay configuration comprises: calculating a RAN part delay information associated with the at least one uplink data packet in the user-plane of the wireless access network node; and transmitting the RAN part delay information to the core network via an uplink PDU session information PDU to the core network in the user-plane.

In some other implementations, a method by a wireless terminal device for monitoring/reporting a data transmission delay between the wireless terminal device and a core network in a wireless network is disclosed. The method may include receiving a transmission delay configuration from control-plane of a wireless access network node, the transmission delay configuration specifying at least one of: a transmission delay provisioning segmentation scheme among a plurality of segmentation schemes; or a monitoring/reporting configuration for the data transmission delay among a plurality of monitoring/reporting configurations. The method may further include transmitting a transmission delay information item to the wireless access network node during a data transmission session between the core network and the wireless terminal device according to the transmission delay configuration.

In the implementations above, the transmission delay provisioning segmentation scheme comprises one of an end-to-end delay scheme or a Radio Access Network (RAN) part delay scheme.

In any of the implementations above, the monitoring/reporting configuration comprises at least one of: a reporting timing configuration; a reporting granularity configuration; or a data packet transmission timestamp scheme.

In any of the implementations above, the reporting timing configuration indicates a reporting frequency or reporting time period.

In any of the implementations above, the reporting granularity configuration indicates reporting the data transmission delay as at least one of: an average data packet delay; a per-packet delay; a packet delay distribution; or a packet delay distribution formula information.

In any of the implementations above the reporting granularity configuration indicates reporting the data transmission delay as the packet delay distribution; the packet delay distribution is included in an uplink protocol data unit (PDU) session frame; and the uplink PDU session frame comprises: a first field indicating a number of delay ranges; and a plurality of blocks of fields, each block of fields comprises a number of packets with delay values falling into one of the delay ranges.

In any of the implementations above, the reporting granularity configuration indicates reporting the data transmission delay as the packet delay distribution formula information; the packet delay distribution formula information is included in an uplink protocol data unit (PDU) session frame; and the uplink PDU session frame comprises: a first field for identifying a packet delay distribution formula; a second field for indicating a number of parameters associated with the packet delay distribution formula; and a block of fields comprising values of the number of parameters.

In any of the implementations above, the reporting granularity configuration indicates reporting the data transmission delay as the per-packet delay; the per-packet delay is included in an uplink protocol data unit (PDU) session frame; and the uplink PDU session frame comprises: a first field indicating a number of per-packet delay samples; and a plurality of second fields each comprising a per-packet delay sample.

In any of the implementations above, the data packet transmission timestamp scheme indicates one of: including transmission time stamps in data packet headers; or including transmission timestamps in packet data converged protocol headers.

In any of the implementations above the data transmission delay is associates with a user-plane of the wireless network.

In any of the implementations above the data transmission delay comprises a downlink user-plane data transmission delay.

In any of the implementations above, further including obtaining receive-timestamp information for at least one downlink data packet and generating the transmission delay information item by calculating an end-to-end or RAN part downlink transmission delay information associated with the at least one downlink data packets according to the receive-timestamp information and the transmission delay configuration; and the transmission delay information item is transmitted to a control-plane of the wireless access network node.

In any of the implementations above, the transmission delay information item is transmitted as a part of a Radio Resource Control (RRC) measurement report.

In any of the implementations above, the data transmission delay comprises an uplink user-plane data transmission delay.

In any of the implementations above, the transmission delay information item comprises timestamp information for at least one uplink data packet transmitted from the wireless terminal device.

In any of the implementations above, the timestamp information for the at least one uplink data packet transmitted from the wireless terminal device is included in headers of the at least one uplink data packet.

In yet some other implementations, a method by a core network node of a wireless network for provisioning a data transmission delay between a wireless terminal device and a core network is disclosed. The method may include sending a transmission delay configuration to a wireless access network node, the transmission delay configuration specifying at least one of: a transmission delay provisioning segmentation scheme among a plurality of segmentation schemes; or a monitoring/reporting configuration for the data transmission delay among a plurality of monitoring/reporting configurations. The method may further include receiving a transmission delay information item from the wireless access network node during a data transmission session between the core network node and the wireless terminal device, the transmission delay information item being generating by wireless access network node or the wireless terminal device according to the transmission delay configuration.

In the implementations above, the transmission delay provisioning segmentation scheme comprises one of an end-to-end delay scheme or a Radio Access Network (RAN) part delay scheme.

In any of the implementations above, the monitoring/reporting configuration comprises at least one of: a reporting timing configuration; a reporting granularity configuration; or a data packet transmission timestamp scheme.

In any of the implementations above the reporting timing configuration indicates a reporting frequency or reporting time period.

In any of the implementations above, the reporting granularity configuration indicates reporting the data transmission delay as at least one of: an average data packet delay; a per-packet delay; a packet delay distribution; or a packet delay distribution formula information.

In any of the implementations above, the reporting granularity configuration indicates reporting the data transmission delay as the packet delay distribution; the packet delay distribution is included in an uplink protocol data unit (PDU) session frame; and the uplink PDU session frame comprises: a first field indicating a number of delay ranges; and a plurality of blocks of fields, each block of fields comprises a number of packets with delay values falling into one of the delay ranges.

In any of the implementations above, the reporting granularity configuration indicates reporting the data transmission delay as the packet delay distribution formula information; the packet delay distribution formula information is included in an uplink protocol data unit (PDU) session frame; and the uplink PDU session frame comprises: a first field for identifying a packet delay distribution formula; a second field for indicating a number of parameters associated with the packet delay distribution formula; and a block of fields comprising values of the number of parameters.

In any of the implementations above, the reporting granularity configuration indicates reporting the data transmission delay as the per-packet delay; the per-packet delay is included in an uplink protocol data unit (PDU) session frame; and the uplink PDU session frame comprises: a first field indicating a number of per-packet delay samples; and a plurality of second fields each comprising a per-packet delay sample.

In any of the implementations above, the data packet transmission timestamp scheme indicates one of: including transmission time stamps in data packet headers; or including transmission timestamps in packet data converged protocol headers.

In any of the implementations above, the data transmission delay is associates with a user-plane of the wireless network.

In any of the implementations above, the data transmission delay comprises a downlink user-plane data transmission delay.

In any of the implementations above, the transmission delay information item: is received from the wireless access network node; and comprises an end-to-end or RAN part downlink transmission delay information associated with at least one downlink data packet as calculated by the wireless terminal device and relayed by the wireless access network node.

In any of the implementations above, the transmission delay information item is received from a control-plane of the wireless access network node in an NG Application Protocol (NGAP) message.

In any of the implementations above, the transmission delay information item is received from the user-plane of the wireless access network node as a header in a PDU session information PDU.

In any of the implementations above, the transmission delay information item comprises the RAN part downlink transmission delay information and the method further comprises: calculating an end-to-end downlink transmission delay information based on the transmission delay information item and core-to-access transmission delay information associated with the at least one downlink data packet.

In any of the implementations above, the transmission delay provisioning segmentation scheme comprises the end-to-end delay scheme; and the transmission delay information item comprises timestamp information for transmitting at least one uplink data packet from the wireless terminal device.

In any of the implementations above, the transmission delay provisioning segmentation scheme comprises the RAN part delay scheme; and the transmission delay information item comprises a RAN part delay information as calculated by the wireless access network node.

In any of the implementations above, the transmission delay information item is received in a NGAP message from a control-plane of the wireless access network node.

In any of the implementations above, the transmission delay information item is received in a PDU session information PDU from the user-plane of the wireless access network node.

In some other implementations, a wireless device comprising a processor and a memory is disclosed. The processor may be configured to read computer code from the memory to implement any one of the methods above.

In yet some other implementations, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations or UEs and a wireless access network node in communication with one another via an over-the-air radio communication interface.

FIG. 3 illustrates a split-architecture for separating a wireless access network node into a central unit (CU) and one or more distributed units (DUs).

FIG. 4 shows various network functions of an example core network.

FIG. 5 shows various network functions of an example 5G core network.

FIG. 6 shows an example flow for configuring a QoS flow with QoS latency monitoring and reporting among a core network, an access network, and a wireless terminal.

FIG. 7 shows an example flow for configurable downlink end-to-end latency monitoring, measurement, calculation, and reporting.

FIG. 8 shows an example flow for configurable uplink end-to-end latency monitoring, measurement, calculation, and reporting.

FIG. 9 shows an example flow for configurable downlink RAN part latency monitoring, measurement, calculation, and reporting.

FIG. 10 shows an example flow for configurable uplink RAN part latency monitoring, measurement, calculation, and reporting.

### DETAILED DESCRIPTION

The technology and examples of implementations and/or embodiments described in this disclosure can be used to facilitate configuration, monitoring, and reporting data transmission delays in a wireless communication network system. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is directed to particularly to monitoring and reporting of uplink and downlink data transmission delay according to a configurable timing and data granularity. The various example implementations disclosed herein provide a mechanism for the network side of the wireless network system to flexibly configure the monitoring, measurement, calculation, and reporting of information related to downlink and uplink data transmission latency in a collaborative manner among the various network nodes, devices and entities, and between the control-plane and user-plane of the wireless network. The disclosed implementations provide a configurable network latency segmentation scheme in addition to configurable timing, data or data flow granularity, content, and format for the monitoring/measurement/calculation/reporting of relevant latency information. The various network devices or nodes are thus coordinated under the adaptive configuration by the network to efficiently monitor, measure, calculate, and report latency information adapted to the need of a particular application and particular data communication session. For the reporting latency information in the user-plane, a special-purpose Protocol Data Unit (PDU) is also designed and constructed.

### Wireless Network Overview

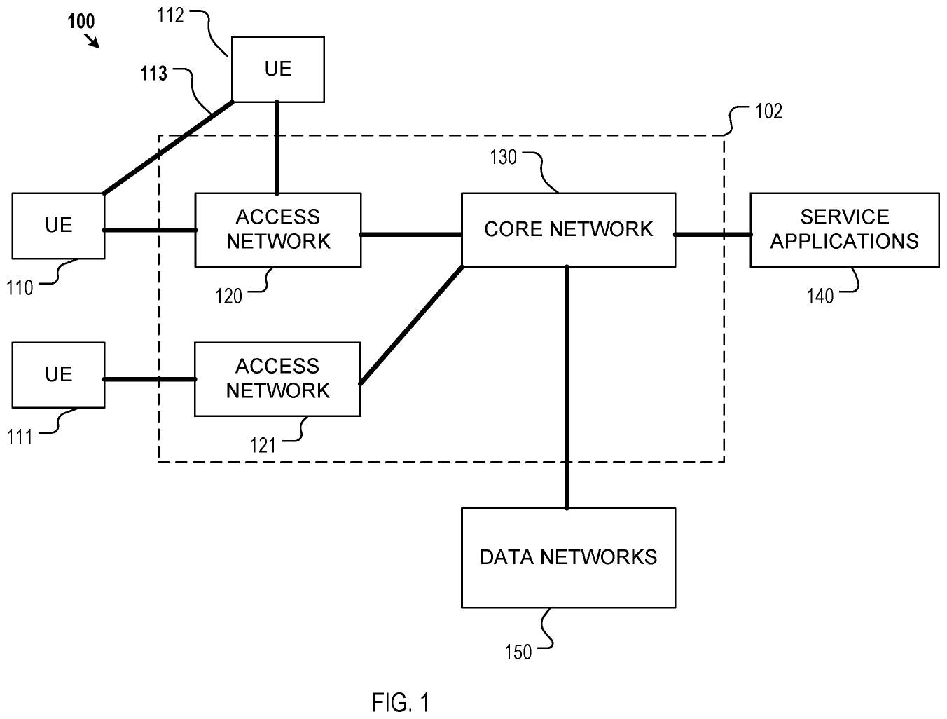

An example wireless communication network, shown as 100 in FIG. 1, may include wireless terminal devices or user equipment (UE) 110, 111, and 112, a carrier network 102, various service applications 140, and other data networks 150. The carrier network 102, for example, may include access networks 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access networks 120 and 121 may be configured as various wireless access network nodes (WANNs, alternatively referred to as base stations) to interact with the UEs on one side of a communication session and the core network 130 on the other. The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the wireless communication network of 100 of FIG. 1, the UEs may communicate with one another via the wireless access network. For example, UE 110 and 112 may be connected to and communicate via the same access network 120. The UEs may communicate with one another via both the access networks and the core network. For example, UE 110 may be connected to the access network 120 whereas UE 111 may be connected to the access network 121, and as such, the UE 110 and UE 111 may communicate to one another via the access network 120 and 121, and the core network 130. The UEs may further communicate with the service applications 140 and the data networks 150 via the core network 130. Further, the UEs may communicate to one another directly via side link communications, as shown by 113.

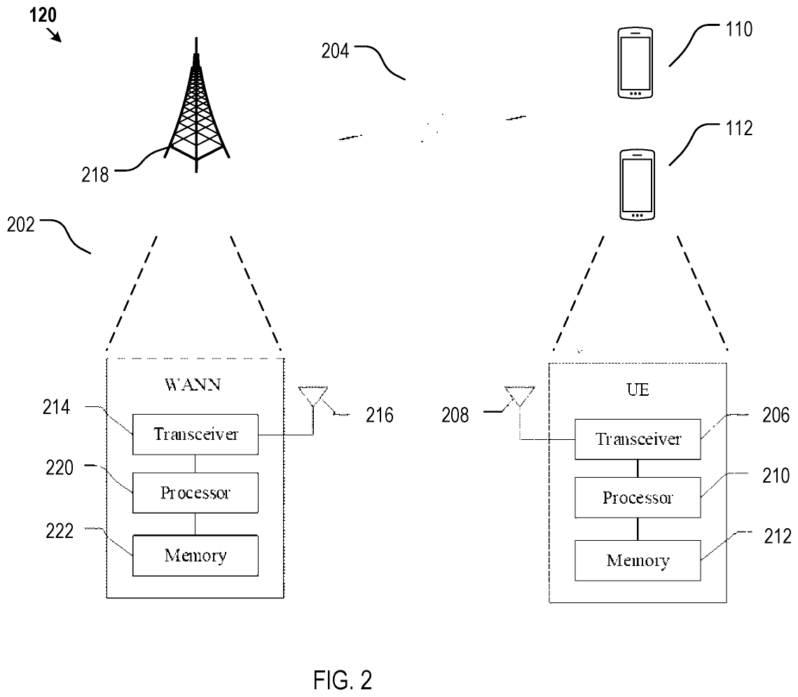

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

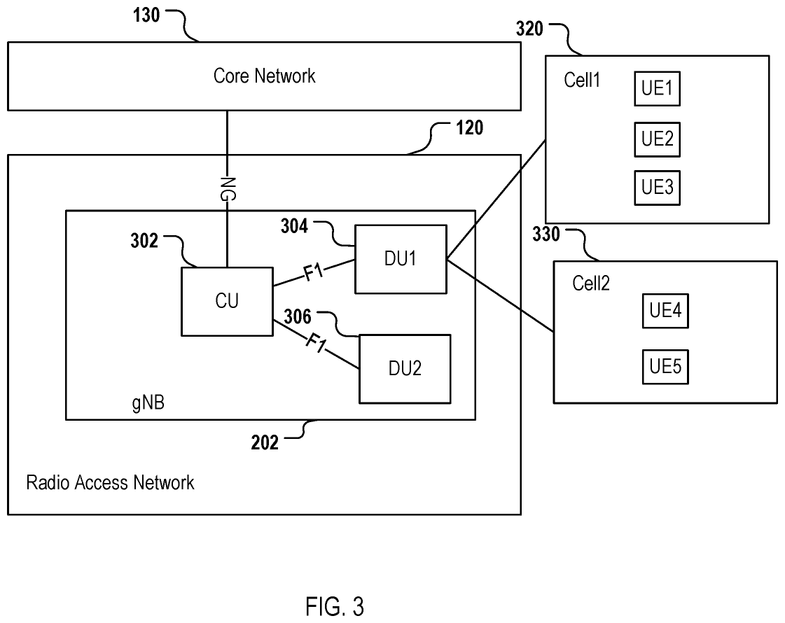

As shown in FIG. 3, one or more base stations 202 of the WANN 120, for example, may include multiple separate access network nodes in the form of a Central Unit (CU) 302 and at least one Distributed Unit (DU) 304 and 306. In a 5G network, for example, a base station may be implemented as a gNB. Correspondingly, a gNB 202 may functionally and/or physically include a gNB-CU 302 and one or more gNB-DUs 304 and 306. For example, a CU may be configured to provide support of higher layers of the communication protocols such as Service Data Adaptation Protocol (SDAP), Packet Data Convergence Protocol (PDCP), and Radio Resource Control (RRC) while a DU may be configured to provides support the lower layers of the protocol stack such as Radio Link Control (RLC), Medium Access Control (MAC) and Physical layer.

In some other implementations, the CU 302 may be further divided into two separate functional or physical entities referred to as CU-CP (the Control-Plane unit of the gNB-CU) hosting RRC entities and CU-UP (the User-Plane unit of the CU) hosting SDAP and PDCP entities. Such separation of the user-plane and control plane in the higher protocol layers (CU layers) in the base stations may provide improved flexibility in the deployment of the access network.

In some implementations, as shown in FIG. 3, the CU 302 may be connected with DU1 304 and DU2 306 via various F1 interface. An F1 interface, for example, may further include an F1-C interface and an F1-U interface, which may be used to carry control-plane information and use-plane information, respectively. The F1-C interface, for example, may be used between the DUs and CU-CP portion of the CU 302, whereas the F1-U interface may be used between the DUs and the CU-UP portion of the CU 302. The gNB 202, for example, may be connected to the core network 130 via an NG interface. When the gNB is separated as CU and DUs, the NG connection to the core network may be implemented between the CU 302 and the core network, as shown in FIG. 3. As further shown in FIG. 3, the UEs may be connected to the core network 130 via the WANN 120 over a radio interface.

As further shown in 320 and 330 of FIG. 3, each of the DUs may serve the UEs via one or more cells. Each cell is associated with a coverage area. These cells may be alternatively referred to as serving cells. The coverage areas between cells may partially overlap. Each UE may be actively communicating with at least one cell while may be potentially connected or connectable to more than one cell. In the example of FIG. 3, UE1, UE2, and UE3 may be served by cell1 320 of the DU1, whereas UE4 and UE5 are served by cell2 330 of the DU1. In some implementations, a UE may be served simultaneously by two or more cells. Each of the UE may be mobile and the signal strength and quality from the various cells at the UE may depend on the UE location. In some embodiments, the CU may be a gNB Central Unit (gNB-CU), and the DU may be a gNB Distributed Unit (gNB-DU). While the various implementations described below are provided in the context of a 5G cellular wireless network, the underlying principles described herein are applicable to other types of radio access networks including but not limited to other generations of cellular network, as well as Wi-Fi, Bluetooth, ZigBee, and WiMax networks.

In some example implementations, the cells shown in FIG. 3 may be alternatively referred to as serving cells. The serving cells may be grouped into serving cell groups (CGs). A serving cell group may be either a Master CG (MCG) or Secondary CG (SCG). Within each type of cell groups, there may be one primary cell and one or more secondary cells. A primary cell in a MSG, for example, may be referred to as a PCell, whereas a primary cell in a SCG may be referred to as PScell. Secondary cells in either an MCG or an SCG may be all referred to as SCell. The primary cells including PCell and PScell may be collectively referred to as SpCell. All these cells may be referred to as serving cells or cells. The term “cell” and “serving cell” may be used interchangeably in a general manner unless specifically differentiated. The term “serving cell” may refer to a cell that is serving, will serve, or may serve the UE. In other words, a “serving cell” may not be currently serving the UE. While the various embodiment described below may at times be referred to one of the types of serving cells above, the underlying principles apply to all types of serving cells in both types of serving cell groups.

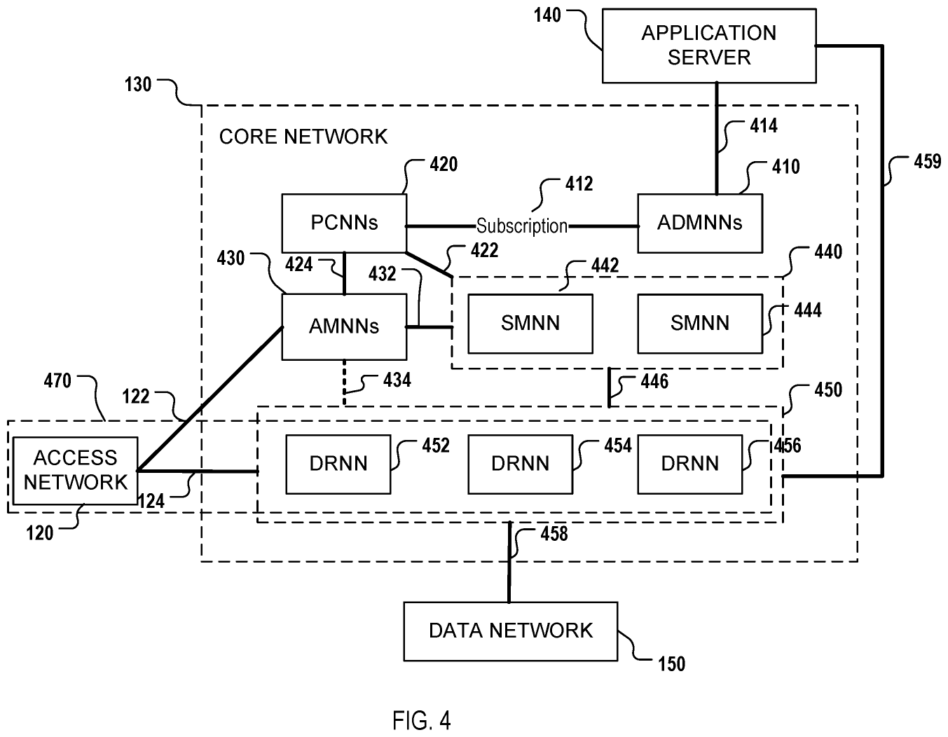

FIG. 4 shows an example division of network functions in the core network 130. While only single instances of network nodes for some functions are illustrated in FIG. 4, those having ordinary skill in the art understand that each of these network functions may be instantiated as multiple instances or network nodes that are distributed throughout the core network 130. Further, each network node in the core network 130 may support one or more the illustrated core network functions. As shown in FIG. 4, the core network 130 may include but are not limited to access management network nodes (AMNNs) 430, session management network nodes (SMNNs) 440, data routing network nodes (DRNNs) 450, policy control network nodes (PCNNs) 420, and application data management network nodes (ADMNNs) 410.

The access management network nodes 430 communicate with the access network 120, the session management network nodes 442, and the policy control network nodes 420 respectively via communication interfaces 122, 432, and 424, and may be responsible for provisioning registration, authentication, and access by UE to the core network 130 was well as allocation of session management network nodes 440 to support a particular UE communication need. The session management network nodes 440 allocated by the access management network nodes 430 may in turn may be responsible for allocating data routing network nodes 450 for supporting the particular UE communication need and control these allocated data routing network nodes 450 via communication interface 446. Alternatively, or additionally in some implementations, the data routing network nodes 450 may be directly allocated by the access management network nodes 430 via the interface 434 and controlled by the session management network 442 via the communication interface 446. Access policies and session routing policies applicable to the UEs may be managed by the policy control network nodes 420 which communicate the policies to the access management network nodes 430 and the session management network nodes 440 via communication interfaces 424 and 422, respectively. The signaling and data exchange between the various types of network nodes through various communication interfaces indicated by the various connection lines in FIG. 4, may be carried by signaling or data messages following predetermined types of format or protocols.

To support a particular end-to-end communication task requested by a UE, a communication session may be established to support a data traffic pipeline for transporting the particular end-to-end communication data traffic. The carrier network portion of the data traffic pipeline, as illustrated by 470 of FIG. 4, may involve one or more network nodes in the access network 120 and a set of data routing network nodes 452, 454, and 456 in the core network 130, as selected and controlled, for example, by a set of session management network nodes 442 and 444 which may be selected and controlled by the access management network nodes 430 that are responsible for establishing and managing the communication session. Data traffic is routed among a UE at one end of the data traffic pipeline, the carrier network portion of the data traffic pipeline (including the set of network nodes in the access network 120 and the selected data routing network nodes 452, 454, and 456 in the core network 130), and another end of the data traffic pipeline including, for example, another UE, the application server 140, or another data network 150, via communication interfaces such as 124, 458, and 459.

The application server 140 may further communicate other configuration and control information to the core network 130. The information communicated to the core network 130 may be referred to as application data. Such application data may be processed and managed by a specific type of network nodes referred to as the application data management network nodes (ADMNNs) 410 in FIG. 4. The application data may be communicated, for example, in a message from the application server 140 to the application data management network nodes 410 via communication interface 414. Alternatively, the application server 140 may access the application data management network nodes 410 using open APIs provided by the core network 130. While FIG. 4 only shows a single application server, those having ordinary skill understand that in practical implementations, the core network 130 may supporting a plurality of service applications of different types.

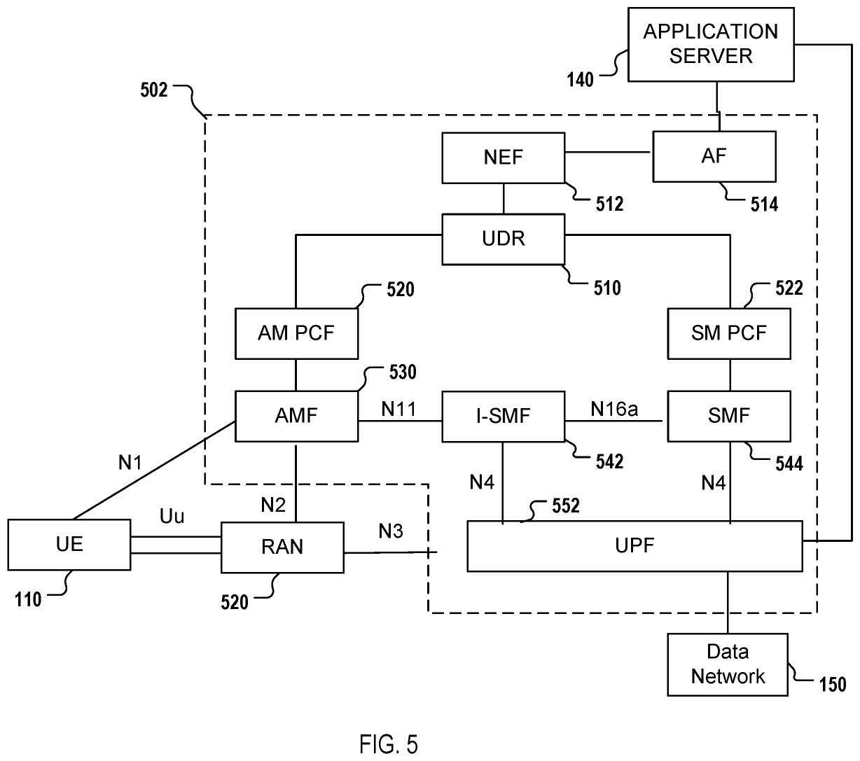

In some specific implementations, FIG. 5 shows that the wireless communication network 500 may include UE 110, application server 140, data network 150, and a carrier network including RAN 520 and core network 502. Corresponding to the more general description of FIG. 4 above, the specific implementation of the core network 502 may include application functions (AF) 514, network exposure functions (NEF) 512, and unified data repository (UDR) functions 510. These three types of network nodes may serve together as the application data management network nodes 410 of FIG. 4. The core network 502 may further include access and mobility management functions (AMF) 530, and session management functions (SMF or I-SMF, denoting intermediate SMF) 544 and 542. The AMF and the SMF serve as the access management network nodes (AMNNs) 430 and the session management network nodes (SMNNs) 440 of FIG. 4, respectively. The AMF 530 and SMFs 544 and 542 may obtain communication policy information from separate access/mobility management policy control functions (AM PCF) 520 and session management policy control function (SM PCF) 522, respectively. The AM PCF 520 and SM PCF 522 serve as the policy control network nodes (PCNNs) 420 of FIG. 4.

As further shown in FIG. 5, each of the SMFs and I-SMFs 522 and 544 controls one or more user-plane functions (UPF) 552. The RAN 520 and one or more UPFs 552 may be allocated by the core network and form a carrier network portion of a data traffic pipeline (or alternatively, a data traffic path) for a particular communication session. The UPFs 552 may serve as the data routing network nodes (DRNNs) 450 of FIG. 4.

The various network nodes or network functions in FIG. 5 communicate signaling information and data through various communication interfaces as indicated by the various connection lines in FIG. 5 using signaling or data messages following predetermined types of format or protocols. Some example communication interfaces as defined, for example, in the 5th generation new radio wireless communication specifications, may be used in the communication network 500 between the various network nodes as indicated by the labels along the connection lines in FIG. 5, including the N1 interface between the UE 110 and the AMF 530 via the RAN 520, the N2 interface between RAN 520 and the AMF 530, the N3 interface between the RAN 520 and the UPFs 550, the N4 interface between the SMFs 542/544 and the UPFs 552, the N11 interface between the AMF 530 and the I-SMFs 542, and the N16a interface between the I-SMFs 542 and the SMFs 544.

### Data Transmission End-to-End Latency

End-to-end latency/delay of data transmission in the wireless communication system described above represents the amount of time that takes a source device to communicate and reach its destination. For uplink communication, the source device may be a wireless terminal or a UE and the destination may be a UPF network node in the core network described above. Likewise, for a downlink communication, the source device may be the UPF network node whereas the destination may be the wireless terminal device or the UE.

In a communication network, an end-to-end communication may be established as a data communication session (alternatively referred to as a data session, or a communication session). Each data session may include transmission of data of different types, characteristics, and transmission requirements. As such, a data session may be configured as containing multiple data flows, with each data flow including data having similar transmission characteristics and/or associated with similar transmission quality requirements. Transmission of each of these data flows may be controlled and configured base on its transmission characteristics/requirements. For examples, allocation of communication resource to the data flow by the communication network may be based on the transmission characteristics/requirements of the data flow.

Such transmission characteristics/requirements for the data flow may be used to determine a set of transmission parameters collectively referred to as a transmission profile for the data flow. The configuration of the transmission of the data flow (such as communication resource allocation) may then be based on such a transmission profile. A data flow may be referred to as Quality of Service (QoS) flow and may be characterized by a set of QoS parameters that are configurable by the network. Data within each of the QoS flows may be transmitted as data packets. The term data packet may be used to refer to the smallest granularity of data units being transmitted, either uplink or downlink. The transmission of data either succeeds or fails at the data packet level. The term data, as referred to in this disclosure, is used in a general sense, including both user data and control information that are transmitted as data packets. The data packets in a QoS flow or more generally in a data communication session, may be associated with an order, so that the received data packets can be assembled to recover the original data in correct sequence.

Transmission of data packets is generally associated with a transmission latency or delay associated with the over-the-air radio interface and the other wired or wireless interface between the various network nodes described above. Some implementations of data transmission, such as the 5G Ultra Reliable Low Latency Communication (URLLC) applications, are intended to provide services with stringent requirements for data transmission latency and service availability. As such, 5G mobile networks supporting URLLC must provide low latency, with minimum packet loss or out-of-order packet arrival. For example, some URLLC services may require that the end-to-end communication latency be under the range of 0.5 ms to 50 ms on the application layer. For another particular example, maximum latency in air interface (or radio latency) may be additionally specified. For some 5G URLLC services, it may be required that such radio interface latency not exceed 1 ms.

Monitoring, measurement, and reporting of network latency, for both uplink and downlink data transmission, is thus critical. For example, such latency information may be used to perform diagnostics of the network and to devise modification for improving the performance of the wireless network. For another example, such latency information may be used to adjust resource allocation and QoS parameters within and among data flows, among data communication sessions, and among different users in order to balance and optimize the overall performance of the network.

In some implementations, the monitoring, measurement, and reporting of network latency may be itself configurable. Such configuration, for example, may be included in network control messages carrying the QoS parameters. Such data transmission latency monitoring, measurement, and reporting configurations may be provided to the various network nodes prior or during an establishment of a data communication session or an establishment of a data flow. The various network nodes may then act accordingly during a communication session to collaboratively support the monitoring and reporting of the network data transmission latency.

Such monitoring/reporting configuration may be designed to provide flexibility by the network to specify the levels, segmentation, data or data flow granularity, timing, format, and other aspects for the various network nodes involved in a communication session to monitor, calculate, and/or report information related to network communication latency, either in the uplink (UL) or downlink (DL) direction.

Particularly, in order to ensure the low end-to-end delay for URLLC, 5G network needs support the performance measurements definitions related to UL/DL packet delay for 5G network. Unlike a traditional latency monitoring and measurement, the end-to-end UL/DL packet delay needs to be measured for the QoS flows per 5G Quality-of-flow Indicator (5QI) between UPF and UE (UE-to-UPF delay). Such end-to-end UL/DL packet delay between UE-and UPF can be measured separately, or by measuring the two segmented delays and adding the two segmented delays together, the two segmented delays being the UL/DL packet delay between UPF and RAN (UPF-to-RAN delay) and the UL/DL packet delay between UE and RAN (UE-to-RAN delay, or the radio interface delay).

The various example implementations below provide improved the network latency monitoring, measurement, and reporting functions over the existing technologies. In particular, the current technologies lack support for the following requirements:
Direct UE-to-UPF delay measurement is not supported. The current technology only supports separate measurements of UPF-to-RAN delay, and UE-to-RAN delay, and then adding these two delays for UE-to-UPF delay. Such method increases the network node and UE processing time and burden, particularly for applications for which only the end-to-end delay is of interest.
The current technology does not support delay measurement per QoS flow and only provide average delay/latency at Data Radio Bearer (DRB) level, which may be an insufficient granularity for some applications.
The current technology does not support network delay monitoring, measurement and reporting at data packet level.
The current technology does not provide various packet level delay statistics such as packet-level delay distribution beyond average delay at DRB level.
The current technology does not take advantage of any CU split into the control-plane and user-plane units.

The various example implementations disclosed herein provide a mechanism for the network side of the wireless network system to flexibly configure the monitoring, measurement, calculation, and reporting of information related to downlink and uplink data transmission latency in a collaborative manner among the various network nodes, devices and entities, and between the control-plane and user-plane of the wireless network. The disclosed implementations provide a configurable network latency segmentation scheme in addition to configurable timing, data or data flow granularity, content, and format for the monitoring/measurement/calculation/reporting of relevant latency information. The various network devices or nodes are thus coordinated under the adaptive configuration by the network to efficiently monitor, measure, calculate, and report latency information adapted to the need of a particular application and particular data communication session. For the reporting latency information in the user-plane, a special-purpose Protocol Data Unit (PDU) is also designed and constructed. Network Latency Monitoring, Measurement, Calculation, and Reporting Configuration

In some example implementations, the adaptive and flexible configuration for monitoring, measuring, calculating, and reporting information related to network latency may be determined by the network side of the wireless communication network. For example, the configuration may be determined by a core network entity/function or node. The configuration information may be delivered to the various network nodes via various control/data messages and various network interfaces.

For a particular non-limiting example, such configuration information may be included as part of the QoS parameter set. In such a manner, the configuration may be provided on the QoS flow level. In other words, for a particular user communication session, each of the distinct QoS flow may be configured separately with respect to the monitoring, measurement, calculation, and reporting of network latency. Such configuration thus may be part of a QoS profile. The QoS profiles may be predefined with each associated with a set of network latency configuration parameters among other QoS parameters. The QoS profiles may be indexed and signaled using the QoS index. Alternatively, the network latency configuration parameters may be explicitly included in a QoS configuration message.

In some example implementations, the network latency configuration parameters may include but are not limited to:

TABLE 1

| Parameter Name | Example Parameter Range | Semantics description |
|---|---|---|
| CHOICE QoS Monitoring | | Either end-to-end (E2E) scheme or |
| Segmentation Schemes | | RAN part scheme |
| >RAN Part Scheme | | |
| >>Reporting Frequency | INTEGER (1, . . . , N) | Indicates the reporting frequency |
| | Units: millisecond | for RAN part UL/DL delay for |
| | e.g., N = 1800000 | QoS monitoring. |
| >>Reporting Granularity | ENUMERATED (Average, | Indicates which report type of the |
| | Per packet, Distribution | measured UL/DL delay results. |
| | Range, Distribution | |
| | Formula . . . ,) | |
| >> Timestamp type | ENUMERATED (IP, | Indicates which type of timestamp |
| | PDCP, . . . ,) | is used for RAN part delay |
| | | calculation. |
| >E2E Delay Scheme | | |
| >>Reporting Frequency | INTEGER (1, . . . , N) | Indicates the reporting frequency |
| | Units: second | for E2E DL delay between UE and |
| | e.g., N = 1800 | UPF for QoS monitoring. |
| | | Units: second |
| >> Reporting Granularity | ENUMERATED (Average, | Indicates which report type of the |
| | Per packet, Distribution | measured DL/UL delay results. |
| | Range, Distribution | |
| | Formula . . . ,) | |
| >> Timestamp type | ENUMERATED (IP, | Indicates which type of timestamp |
| | PDCP, . . . ,) | is used for E2E delay calculation. |

As shown by the example above, the network may configure two types of delay measurement for a QoS flow, including a RAN part delay measurement (delay between NG-RAN (gNB) and UE), and an end-to-end (E2E) delay (delay between UPF of CN (core network) and UE) measurement.

As further shown by the example above, for each QoS flow, The QoS latency configuration can be defined within the QoS parameters, wherein the QoS latency configuration comprises at least one of the following parameters:
A Choice Indication or flag to indicated whether RAN part delay (e.g., delay between NG-RAN (gNB) and UE) is configured to measure, or the E2E delay (e.g., delay between UPF of CN (core network) and UE) is configured to measure. This flat provides a flexibility for the system to determine according to a particular application or QoS whether only E2E latency is of interest or finer granularity in terms of segmented latency (e.g., the radio interface latency) alternative or in addition to the E2E latency is also of interest.
A Reporting Frequency or Time Period to indicate a reporting frequency or time period for UL/DL RAN part or E2E delay measurement (note that in the case that E2E delay scheme is chosen, the UL E2E delay may be calculated at CN, and the RAN may only need to report DL E2E delay measurement). The reporting period may be specified as absolute time length in unit of, for example, seconds. Alternatively, an index among a set of predefined indices may be used to indicate the reporting time period. Each of the indices may correspond to a particular reporting time period, which may be predefined. Alternatively, a reporting frequency may be specified. The reporting frequency may be an inverse of the reporting period.
A Timestamp Type to indicate which type of timestamp is to be used when needed. For example, the types of timestamp may include including timestamps in IP headers (i.e., in a header of each data packet), or including timestamps in PDCP headers or information fields. The IP header timestamp scheme refers to inserting a timestamp in an Internet Protocol (IP) header of an IP packet associated with the QoS flow whereas the PDCP timestamp scheme refers to inserting a timestamp in a PDCP header or information field of an PDCP protocol data unit (PDU) associated with the QoS flow. A timestamp so included indicates the time when the packet is sent from a PDCP entity or arrives at the PDCP entity and may be used by a recipient network device or node of the timestamp for deriving or calculating uplink or downlink latencies along with other timing information.
A Reporting Granularity to indicate report type of the results/information of the monitored or measured latency information. As an example, the granularity type may indicate whether the report should be made on per packet level, per QoS flow level, packet statistical level, and the like. For example, the granularity types may include one of: a packet average, per packet, distribution range/histogram, distribution formula, and the like. The Reporting Granularity parameter may indicate which of these predefined granularity schemes should be used for a particularly configured QoS flow. Such a parameter may be included in the QoS parameter set as an index or enumeration value corresponding to the predefined granularity configuration. For example, if “average” type is indicated, the NG-RAN (gNB) may report the average delay result of all packets samples of a certain period (e.g., the reporting time period described above). If “per packet” type is indicated, the NG-RAN (gNB) may report all the delay/latency results of all the packets samples during the reporting time period as a list. If “distribution range” type is indicated, the NG-RAN (gNB) may report the detail delay distribution of all the packets samples during the reporting time period as, for example a histogram indicating number of packets for each of a plurality of latency ranges. If “distribution formula” type is indicated, the NG-RAN (gNB) may report a parameterized mathematical distribution formula of all the packets samples during a reporting time period. Rather than, a numerical histogram, the report may instead indicate a formula among a set of distribution formulae being used to describe the packet level latency distribution (using a predefined set of formulae and indices for these formulae) and the values of the measured/derived parameters associated with the indicated formula.

### Configuration Process for Latency Monitoring, Measurement, Calculation, and Reporting Parameters

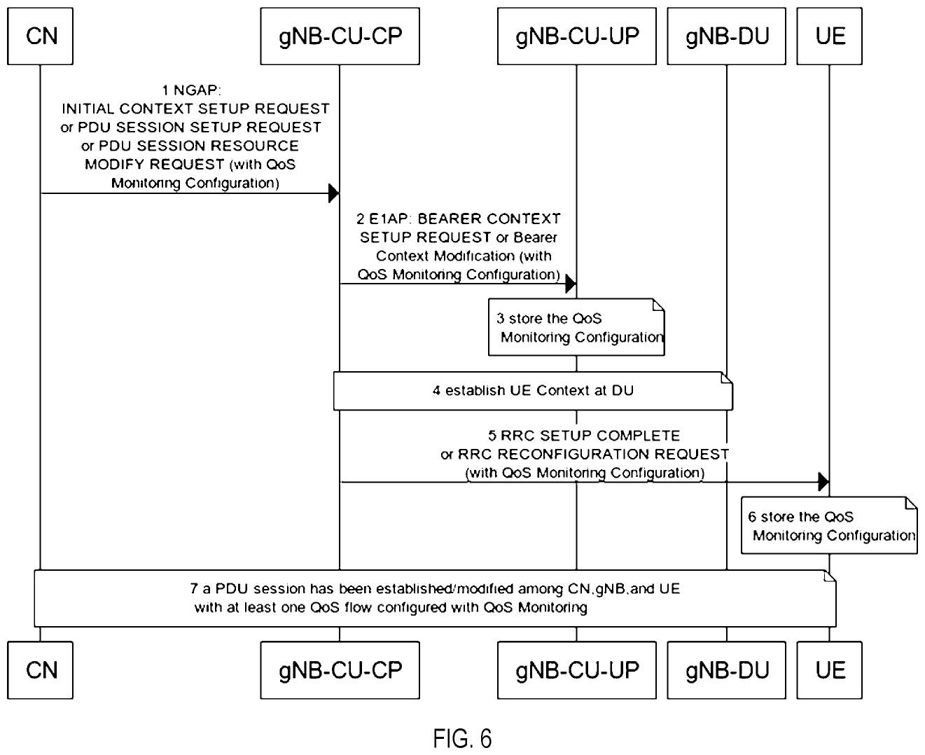

The various parameters for data transmission latency monitoring, measuring, calculating, and reporting configuration may be provided from the core network side for each of the QoS flow. An example procedure is provided in FIG. 6 and described in further detail below.

Specifically, FIG. 6 illustrates a flow diagram for configurating a QoS flow with QoS network latency monitoring, measurement, calculation, and reporting parameters among the core network, the access network, and the UE. Specific references to 5G network terminology may be used in FIG. 6, but no such limitation is intended in the description below and the underlying principles disclosed below applies broadly to other wireless communication systems.

As shown in FIG. 6, in Step 1, the CN may send a message, e.g., an initial context setup request message or PDU session setup/modify request message to the access network, e.g., gNB (the gNB-CU-CP in the case of CP/UP split of the gNB, as described above) to request assigning/modifying resources for one or several PDU session, for each QoS flow in a PDU session. The QoS Monitoring Configuration as described above and determined by the network for a QoS may be optional included within the QoS parameter set in the message. Such a message, for example may be sent as an NG Application Protocol (NGAP) in the control-plane. As such, such message may be received by the control plane of the access network. As shown in FIG. 6, such a message would be received by the gNB-CU-CP in case of a functional and/or physically split of the CP and UP functions in the access network.

In Step 2, the access network, e.g., the gNB-CU-CP sends a message, e.g., a bearer context setup/modification request message to the use-plane of the access network, e.g., the gNB-CU-UP in case of CP-UP split, to request assigning/modifying resources for one or several PDU session, for each QoS flow in a PDU session. The QoS Monitoring Configuration may be optional included within the QoS parameters in the message. As an example, such a message may be implemented as an E1 message.

In Step 3, the access network node, e.g., the gNB-CU-UP stores the received QoS latency configuration for the QoS flow in, e.g., the user-plane of the access network node as a basis for later actions related to latency monitoring, measurement, calculation, and reporting.

In Step 4, a UE context at the gNB-DU is established under the provisioning of the gNB-CU-CP.

In Step 5, the gNB-CU-CP sends an RRC message, e.g., an RRC Setup complete message or RRC reconfiguration request message to the UE, for each QoS flow in the PDU session. The QoS latency configuration may be optional included within the QoS parameters in the message such that the UE is informed by these latency configuration parameters.

In Step 6, the UE stores the received QoS latency configuration for the QoS flow such that the UE may determine its actions in monitoring, measuring, calculating, and reporting the QoS data packet network latency information based on such QoS latency configuration.

In Step 7, the PDU session may be established/modified among the CN, the access network, e.g., the gNB, and the UE with at least one of the QoS flows being configured with QoS latency monitoring, measuring, calculating, and reporting configuration.

### Example DL Direct E2E Latency Monitoring, Measurement, Calculation, and Reporting Schemes

Under the direct E2E latency monitoring scheme as configured, the network may collaboratively monitor, measure, exchange, calculate and report information relevant to the E2E latency result as configured (e.g., average, per-packet, distribution range, or distribution formula) for DL packets of a QoS flow.

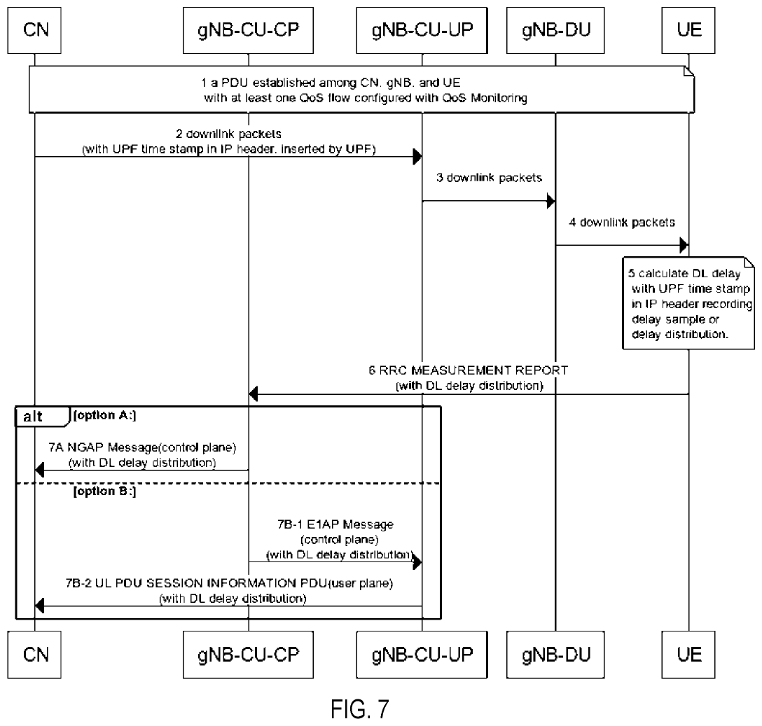

FIG. 7 shows an example flow diagram for monitoring, measuring, exchanging, calculating and reporting latency information pertaining to DL E2E delay from the UPF to the UE.

As shown in FIG. 7, in Step 1, a PDU session may be establish among the CN, the gNB, and the UE with at least one QoS flow configured with QoS latency configuration as described above in relation to FIG. 6. It is assumed that the QoS latency configuration indicate a E2E scheme.

In Step 2, after the UPF determines that the E2E delay scheme is used according the QoS latency configuration for a QoS flow, the UPF of the CN may send at least one downlink user-plane packet to the user-plane of the access network (e.g., the gNB-CU-UP) with corresponding UPF timestamps. Such timestamps may be included, for example, in the Internet Protocol (IP) header of the corresponding one or more IP packet of the QoS flow. The IP packet may be encapsulated in a downlink user-plane packet. The UPF timestamps may indicate the time instances when the at last one encapsulated IP packet is sent from the UPF or arrives at the UPF.

In Step 3, the gNB-CU-UP may send the downlink user-plane packet to the gNB-DU (if CU-DU split is implemented in the access network).

In Step 4, the gNB-DU may send the downlink user-plane packet to the UE.

In Step 5, after UE determines that the E2E latency scheme is used according the QoS latency configuration for a QoS flow, the PDCP layer of the UE may calculate E2E DL delays between UPF and UE of the received at least one downlink IP packet by subtracting UPF timestamps included in the IP header of the at least one IP packet from the times when the at least one IP packet arrives at the PDCP entity of the UE. The UE may further record the calculated delay or latency results of the at least one DL packet.

In Step 6, the UE may measure/monitor/calculate the DL E2E delay for a reporting time period as indicated in the QoS latency configuration. The UE may then send an RRC message with DL E2E delay reporting information items to the control plane of the access network, e.g., the gNB-CU-CP via the gNB-DU. The E2E delay reporting information item may be generated according to the QoS latency configuration described above. Such reporting information item thus may include, for example, average delay, per-packet delay, delay distribution histogram, or delay distribution formula during the reporting time period, as configured in the QoS latency configuration.

In the example implementations above, the delay distribution information for the QoS flow may include but is not limited to at least one of the following.
A list of the delay distribution range or latency histogram. Specifically, each item of this list may indicate the delay sample numbers in a specific delay value range, where each value range may be defined as a low delay value and a high delay value of the value range. Each item of the list may include at least one of the following: a “Range ID” to indicate a predefined delay value range, a “Range Start/end” pair to indicate the range by lowest/highest value of the range, and “a number of Samples” to indicate the number of packets with measured network delay result in the delay value range corresponding to the “Range ID” or the “Range Start/end” pair. For example, Rang ID=1 may represent delay values between [0, 0.2 ms), Rang ID=2 may represent delay values between [0.2, 0.4 ms), Rang ID=3 may represent delay values between [0.4, 0.6 ms), etc. Likewise, the “Range Start/end” pair may indicate the lowest/highest value of the range. For example, for the delay range of (0.2 ms, 0.4 ms), the “Range Start” of the pair may be set to 0.2, the “Rang End” of the pair may be set to 0.4.)
A list of the raw delay samples for distribution calculation. Each item of the list indicates the delay result for one packet, and may optional include the PDCP Sequence Number associated with the measured packet. Such information may be used by other network node to perform desired derivations or calculations.
Information items corresponding to a parameterized mathematical delay distribution Formula. Such information items may include at least one of: “Delay Distribution Formula ID” for indicating the predefined delay distribution formula or probability density formula for delay distribution; “Formula parameter Number” indicating a number of parameters of the selected parameterized mathematical Distribution formula; “a list of the parameters of the formula”, where each item of the list indicates the value of a parameter of the used Distribution formula in a corresponding order. For example, in the case that a Normal probability density formula is selected, as shown below.

TABLE 2

| Normal probability density formula | Components |
|---|---|
| $f ( x ) = \frac{1}{σ \sqrt{2 π}} {e}^{- \frac{{( x - μ )}^{2}}{2 {σ}^{2}}}$ | f(x) = probability x = value of the variable (delay/latency) μ = mean delay/latency |
| | σ = standard deviation |
| | σ² = variance |

The information items above corresponding to the selected normal probability formula may represent the following.
Delay Distribution Formula ID: ID=1 indicates the Normal probability density formula is used.
Formula parameter Number: equals=2 (only two parameters, μ and σ)
First item of the Formula parameter list: the value of μ, the first parameter.
Second item of the Formula parameter list: the value of σ, the second parameter.

Returning to FIG. 7, in Step 7, the QoS delay information during the reporting time period may be reported to the core network by the access network. Such reporting may be implemented via two example optional manners.

In the optional implementation shown as Step 7A, the report may be implemented in the control plane. Specifically, after receiving the RRC message with the DL delay information item(s) sent from the UE, the gNB-CU-CP may send, for example, an NGAP message with the DL delay information item(s) to the CN.

In the optional implementation shown as Steps 7B, the report may instead be implemented in the user-plane. Particularly as shown in Step 7B-1 of FIG. 7, after receiving the RRC message with the DL delay information item(s) sent by the UE, the gNB-CU-CP sends a message (e.g., E1 Application Protocol (E1AP) message) with the DL delay information item(s) included, to the user-plane of the access network node, e.g., gNB-CU-UP. Further in Step 7B-2, after receiving the message with the DL delay information item(s) sent from the gNB-CU-CP, the gNB-CU-UP sends a user-plane data, such as a NG-U packet with the DL delay information items included, to the UPF of the CN. The NG-U packet, for example, may be implemented as a UL PDU SESSION INFORMATION PDU and the like. In other words, the NG-U packet may be encapsulated in a special PDU which is used to report UL PDU session information, and in this case, the UL PDU session information includes the QoS delay information item(s).

### Example UL Direct E2E Latency Monitoring, Measurement, Calculation, and Reporting Schemes

Under the direct E2E latency monitoring scheme as configured, the network may collaboratively monitor, measure, exchange, calculate and report information relevant to the E2E latency result as configured (e.g., average, per-packet, distribution range, or distribution formula) for UL packets of a QoS flow.

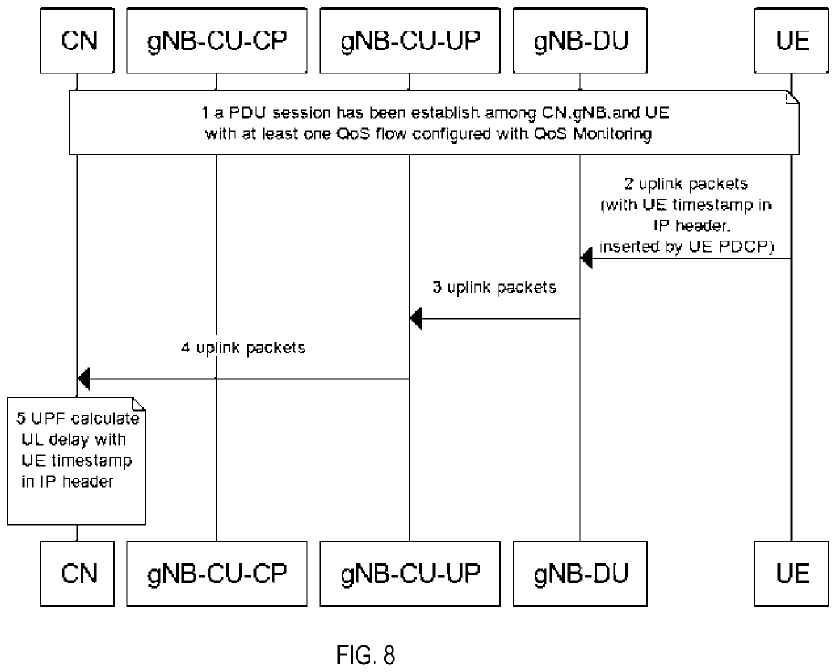

FIG. 8 shows an example flow diagram for monitoring, measuring, exchanging, calculating and reporting latency information pertaining to UL E2E delay from the UE to the UPF.

As shown in FIG. 8, in Step 1, a PDU session may be establish among CN, the gNB, and UE with at least one QoS flow configured with QoS latency configuration as described above in relation to FIG. 6. It is assumed that the QoS latency configuration indicate a E2E scheme.

In Step 2, the UE may send an uplink user-plane packet with a UE timestamp in an Internet Protocol (IP) header of an IP packet associated with the QoS flow to the gNB-DU. The IP packet may be encapsulated in the uplink user-plane packet. The UE timestamp may indicate the time when the encapsulated IP packet being sent from, for example, the PDCP layer of the UE.

In Step 3, the gNB-DU may send the uplink user-plane packet to the gNB-CU-UP (if CU-DU split is implemented in the access network).

In Step 4, the gNB-CU-UP may send the uplink user plane-packet to the UPF of the CN.

In Step 5, the UPF of the CN may calculate UL delay/latency between UPF and UE of the received uplink IP packet by subtracting the UE timestamp in the IP header of the IP packet from the time when the IP packet arrives at the UPF. The UPF may further record the delay/latency results of each UL packet. The UPF may measure the UL delay for a certain period (e.g., the configured reporting time period described above), and use the collected UL delay results to determine the UL E2E delay distribution (histogram or distribution formula) as described above.

### Example DL RAN Part Latency Monitoring, Measurement, Calculation, and Reporting Schemes

Under the RAN part latency monitoring scheme as configured, the network may collaboratively monitor, measure, exchange, calculate and report information relevant to the RAN part latency result as configured (e.g., average, per-packet, distribution range, or distribution formula) for DL packets of a QoS flow.

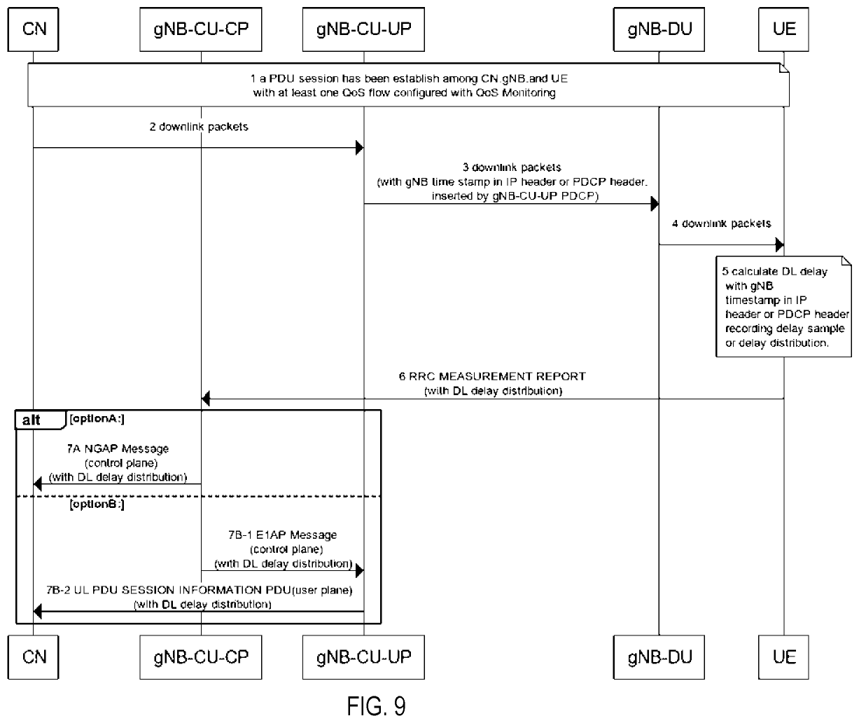

FIG. 9 shows an example flow diagram for monitoring, measuring, exchanging, calculating and reporting latency information pertaining to DL RAN part delay.

As shown in FIG. 9, in Step 1, a PDU session may be establish among CN, the gNB, and the UE with at least one QoS flow configured with QoS Monitoring Configuration. It is assumed that the QoS latency configuration indicate the RAN part latency scheme.

In Step 2, the UPF of CN may send the downlink user-plane packet to the gNB-CU-UP.

In Step 3, the gNB-CU-UP may send a PDCP PDU associated with the QoS flow, with a gNB timestamp in the PDCP PDU header or in an IP header of an IP packet encapsulated in the PDCP PDU, to the gNB-DU. The gNB timestamp may indicate the time when the PDCP PDU is sent from the PDCP layer/entity of the gNB or the time when the corresponding PDCP SDU arrives at the PDCP layer of the gNB.

In Step 4, the gNB-DU may send the downlink user-plane packet to the UE.

In Step 5, the PDCP layer of the UE may calculate DL delay/latency between the gNB and UE of the received downlink PDCP PDU by subtracting the gNB timestamp included in the PDCP PDU header or the IP packet header therein from the time when the PDCP PDU arrives at the PDCP layer/entity of the UE. The UE may further record the delay/latency results of the DL packets as the RAN part delay/latency.

In Step 6, the UE may measure the RAN part DL delay for a certain period (e.g., the configured reporting time period as described above). The UE may then send an RRC message with at least one delay information items related to the RAN part DL delay according the UE's stored QoS latency configuration of the corresponding QoS flow (e.g., average delay, per-package delay, distribution ranges, and/or distribution formula information, as described above) to the gNB-CU-CP via gNB-DU.

In Step 7, the control-plane of the access network, e.g., the gNB-CU-CP, any report the delay/latency information items to the CN. Such reporting may be implemented via two example optional manners.

In the optional implementation shown as Step 7A, the report may be implemented in the control plane. Specifically, as shown in Step 7A, after receiving the RRC message with the delay information items sent by the UE, the gNB-CU-CP sends from the control-plane of the access network, for example, an NGAP message with the delay information items, to the CN.

In the optional implementation shown in Steps 7B, the report may instead be implemented in the user-plane. Particularly as shown in Step 7B-1, after receiving the RRC message with the delay information items sent by the UE, the gNB-CU-CP sends a message, e.g., a E1AP message, with the delay information items to the user-plane of the access network, e.g., the gNB-CU-UP. Further in Step 7B-2, after receiving the message with the delay information items sent by the gNB-CU-CP, the gNB-CU-UP sends a user-plane package, such as an NG-U packet with the delay information items, to the UPF of the CN. The NG-U packet, for example, may be implemented as a UL PDU SESSION INFORMATION PDU and the like. In other words, the NG-U packet may be encapsulated in a special PDU which is used to report UL PDU session information, and in this case, the UL PDU session information includes the QoS delay information item(s).

### Example UL RAN Part Latency Monitoring, Measurement, Calculation, and Reporting Schemes

Under the RAN part latency monitoring scheme as configured, the network may collaboratively monitor, measure, exchange, calculate and report information relevant to the RAN part latency result as configured (e.g., average, per-packet, distribution range, or distribution formula) for UL packets of a QoS flow.

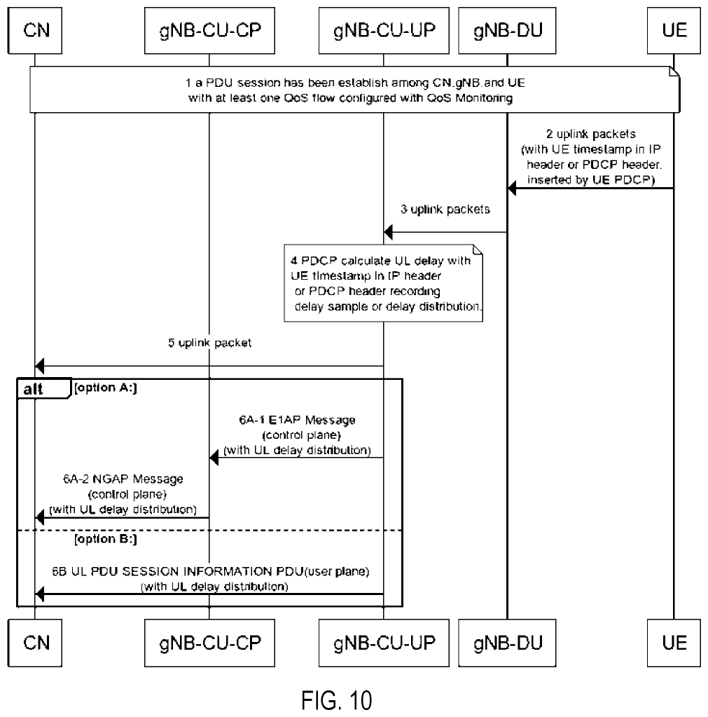

FIG. 10 shows an example flow diagram for monitoring, measuring, exchanging, calculating and reporting latency information pertaining to UL RAN part delay.

As shown in FIG. 10, in Step 1, a PDU session may be establish among CN, the gNB, and the UE with at least one QoS flow configured with QoS latency configuration. It is assumed that the QoS latency configuration indicate a RAN part latency scheme.

In Step 2, the UE may send a PDCP PDU associated with the QoS flow, with a UE timestamp in the PDCP PDU header or in an IP header of an IP packet encapsulated in the PDCP PDU, to the gNB-DU. The UE time stamp indicates the time when the PDCP PDU is sent from the PDCP layer/entity of the UE or the time when the corresponding PDCP SDU arrives at the PDCP layer/entity of the UE.

In Step 3, the gNB-DU may send the uplink user-plane packet to the gNB-CU-UP.

In Step 4, after receiving the PDCP PDU sent by the UE, the gNB-CU-UP (or PDCP layer/entity of the gNB) may calculate UL transmission delay/latency between gNB and UE of the received uplink PDCP PDU by subtracting the UE timestamp from the time when the PDCP PDU arrives at the gNB-CU-UP (PDCP layer/entity of the gNB). The UE timestamp may be extracted from the IP header of the IP packet encapsulated in the PDCP PDU or in the PDCP PDU header. The gNB-CU-UP may then records the delay/latency results of the UL packets as the RAN part latency.

In Step 5, the gNB-CU-UP may further send the uplink user-plane packet to the UPF of the CN.

In Steps 6, the RAN part QoS latency information may be reported to the CN by the access network. Such reporting may be implemented via two example optional manners.

In the optional implementation shown as Steps 6A, the report may be implemented in the control plane. Specifically, in Step 6A-1, the gNB-CU-UP may measure the RAN part UL delay for a certain period of time (e.g., the configured reporting time period). The gNB-CU-UP may then send a message, e.g., an E1AP message with the at least one of the delay information items for RAN part UL delay for a QoS flow, according the gNB-CU-UP's stored QoS latency configuration of the QoS flow, to the control-plane of the access network, e.g., the gNB-CU-CP. Further in Step 6A-2, after receiving the message with the latency information items sent by the gNB-CU-UP, the gNB-CU-CP then sends a control-plane message, e.g., an NGAP message with the DL delay information items, to the CN.

In the optional implementation shown as Step 6B, the report may be implemented in the user-plane. Specifically, as shown in Step 6B of FIG. 6, the gNB-CU-UP measures RAN part UL delay for a certain configured time period, and then send a user-plane package, e.g., an NG-U packet with the at least one of the delay information items for RAN part UL delay for a QoS flow, according the gNB-CU-UP's stored QoS latency configuration of the QoS flow, to the UPF of the CN. The NG-U packet, for example, may be implemented as a UL PDU SESSION INFORMATION PDU and the like. In other words, the NG-U packet may be encapsulated in a special PDU which is used to report UL PDU session information, and in this case, the UL PDU session information includes the QoS delay information item(s).

### UL PDU Session PDU for Reporting Latency Information Item Containing Latency Distribution Range IDs

As described above with respect to the implementations of FIGS. 7, 9, and 10, a UL PDU session PDU may be constructed for reporting the QoS latency information from the user-plane of the access network, e.g., gNB-CU-UP, to the core network. It may be viewed as special-purpose user-plane PDU in parallel with other ordinary data PDUs.

In some implementations, such special-purpose PDU may be constructed for reporting latency information items including latency distribution information related to latency range IDs as described above. An example construction of such a PDU is illustrated below, which shows a UL PDU SESSION INFORMATION PDU (referred to as PDU Type 1) format with various UL/DL delay distribution information fields definition. Again, such a UL PDU SESSION INFORMATION PDU may be used to carry the UL/DL delay information related to measured distribution of latency ranges with range IDs to UPF of the CN. It shall be further understood, other types of PDU(s) can also be constructed include similar fields to carry the UL/DL delay distribution information to a target network node.

TABLE 3

| Bits | | | | | | | | Number of |
|---|---|---|---|---|---|---|---|---|
| 7 | 6 | 5 | 4 | 3 | 2 | 1 | 0 | Octets |
| PDU Type (=1) | | | | QMP | DL | UL | SNP | 1 |
| | | | | | Delay | Delay | | |
| | | | | | Ind. | Ind. | | |
| N3/N9 | New | QoS Flow Identifier | | | | | | 1 |
| Delay | IE | | | | | | | |
| Ind. | Flag | | | | | | | |
| DL Sending Time Stamp Repeated | | | | | | | | 0 or 8 |
| DL Received Time Stamp | | | | | | | | 0 or 8 |
| UL Sending Time Stamp | | | | | | | | 0 or 8 |
| DL Delay Result | | | | | | | | 0 or 4 |
| UL Delay Result | | | | | | | | 0 or 4 |
| UL QFI Sequence Number | | | | | | | | 0 or 3 |
| N3/N9 Delay Result | | | | | | | | 0 or 4 |
| DL Delay Distribution Range Number | | | | | | | | 0 or 1 |
| Range ID of DL | | | | | | | | 0 or 1 |
| Number of DL Samples in Range | | | | | | | | 0 or 1 |
| Range ID of DL | | | | | | | | 0 or 1 |
| Number of DL Samples in Range | | | | | | | | 0 or 1 |
| . . . | | | | | | | | 0 or (2*DL |
| | | | | | | | | Delay Range |
| | | | | | | | | Number Octet) |
| UL Delay Distribution Range Number | | | | | | | | 0 or 1 |
| Range ID of UL | | | | | | | | 0 or 1 |
| Number of UL Samples in Range | | | | | | | | 0 or 1 |
| Range ID of UL | | | | | | | | 0 or 1 |
| Number of UL Samples in Range | | | | | | | | 0 or 1 |
| . . . | | | | | | | | 0 or (2*DL |
| | | | | | | | | Delay Range |
| | | | | | | | | Number Octet) |
| DL | DL | UL | New | New | New | New | New | 0 or 1 |
| Delay | Delay | Delay | IE | IE | IE | IE | IE | New IE |
| Dist Ind | Dist | Dist | Flag | Flag 3 | Flag 2 | Flag 1 | Flag | Flags |
| | for | Ind | 4 | | | | 0 | Octet |
| | E2E | | | | | | | |
| | Ind | | | | | | | |

Besides the usual PDU fields, the various latency/delay information fields are described in further detail below. The UL Dist Ind (distribution indication) field (1 bit, value=0 or 1) may be included. For example, if this bit is set to “1”, the DL delay distribution information is indicated included/present in the PDU. Otherwise, such information is not included in the PDU.

A DL Delay Dist (distribution) for E2E Ind (indication) Field (1 bit, value=0 or 1) may be included. This parameter indicates whether the DL delay distribution results is the RAN part delay (delay between NG-RAN and UE) or E2E delay (delay between UPF and UE) (e.g., value 0 corresponds to RAN part delay, and value 1 corresponds to E2E delay).

A UL Delay Dist Ind (distribution indication) Field (1 bit, value=0 or 1) may also be included. If the bit is set to “1”, the UL RAN part delay (between NG-RAN and UE) distribution information is included/present in the PDU. Otherwise, such information is not included in the PDU.

A DL Delay Distribution Range Number Field may be included. This parameter, when included, indicates how may delay ranges (blocks) are configured for the present DL delay distribution information. In one example, as shown in Table 3 above, this field, when included may occupy one octet, providing an indication of up to 255 number of DL delay ranges.

For each of the DL latency ranges, a corresponding set of fields may be included to carry the distribution information for each DL latency range, including a “Range ID of DL” field and a “number of DL Samples in Range” field, each occupies one octet, for example. The “Range ID of DL” Field may indicate a DL delay range which is predefined. For example, Rang ID=1 may represent a DL latency delay range of [0, 0.2 ms), Rang ID=2 may represent a DL latency value range of [0.2, 0.4 ms), Rang ID=3 may represent a DL latency value range of [0.4, 0.6 ms), etc. For another example, the “Number of DL Samples in Range” may be an integer representing the number of packets measured with the DL delay result within the corresponding latency value range indicated by the Range ID. As shown in Table 3, these two fields repeat in the PDU for the “DL Delay Distribution Range Number” of times.

Further, a “UL Delay Distribution Range Number” Field may be included. This parameter, when included, indicates how may delay ranges (blocks) are configured for the present UL delay distribution information. In one example, as shown in Table 3 above, this field, when included may occupy one octet, providing an indication of up to 255 number of UL delay ranges.

For each of the UL latency ranges, a corresponding set of fields may be included to carry the distribution information for each UL latency range, including a “Range ID of UL” field and a “number of UL Samples in Range” field, each occupies one octet, for example. The “Range ID of UL” Field may indicate a UL delay range which is predefined. For example, Rang ID=1 may represent a UL latency delay range of [0, 0.2 ms), Rang ID=2 may represent a UL latency value range of [0.2, 0.4 ms), Rang ID=3 may represent a UL latency value range of [0.4, 0.6 ms), etc. For another example, the “Number of UL Samples in Range” may be an integer representing the number of packets measured with the UL delay result within the corresponding latency value range indicated by the Range ID. As shown in Table 3, these two fields repeat in the PDU for the “UL Delay Distribution Range Number” of times.

### UL PDU Session PDU for Reporting Latency Information Item Containing Latency Distribution Range Start/End Pairs

In some implementations, such special-purpose PDU may be constructed for reporting latency information items including latency distribution range start/end pair information. An example construction of such PUD is illustrated below, which shows a UL PDU SESSION INFORMATION PDU (referred to as PDU Type 1) format with the UL/DL delay distribution information fields definition. Again, such a UL PDU SESSION INFORMATION PDU may be used to carry the UL/DL delay distribution information related to latency ranges associated with start/end value pairs to UPF of the CN. It shall be further understood, other types of PDU(s) can also be constructed to include similar fields to carry the UL/DL delay distribution information related to latency ranges having start/end value pairs to a target network node.

TABLE 4

| Bits | | | | | | | | |
|---|---|---|---|---|---|---|---|---|
| 7 | 6 | 5 | 4 | 3 | 2 | 1 | 0 | Number of Octets |
| PDU Type (=1) | | | | QMP | DL | UL | SNP | 1 |
| | | | | | Delay | Delay | | |
| | | | | | Ind. | Ind. | | |
| N3/N9 | New | QoS Flow Identifier | | | | | | 1 |
| Delay | IE | | | | | | | |
| Ind. | Flag | | | | | | | |
| DL Sending Time Stamp Repeated | | | | | | | | 0 or 8 |
| DL Received Time Stamp | | | | | | | | 0 or 8 |
| UL Sending Time Stamp | | | | | | | | 0 or 8 |
| DL Delay Result | | | | | | | | 0 or 4 |
| UL Delay Result | | | | | | | | 0 or 4 |
| UL QFI Sequence Number | | | | | | | | 0 or 3 |
| N3/N9 Delay Result | | | | | | | | 0 or 4 |
| DL Delay Distribution Range Number | | | | | | | | 0 or 1 |
| Range Start | | | | | | | | 0 or 1 |
| Range End | | | | | | | | 0 or 1 |
| Number of DL Samples in Range | | | | | | | | 0 or 1 |
| Range Start | | | | | | | | 0 or 1 |
| Range End | | | | | | | | 0 or 1 |
| Number of DL Samples in Range | | | | | | | | 0 or 1 |
| . . . | | | | | | | | 0 or (3*DL Delay |
| | | | | | | | | Range Number |
| | | | | | | | | Octet) |
| UL Delay Distribution Range Number | | | | | | | | 0 or 1 |
| Range Start | | | | | | | | 0 or 1 |
| Range End | | | | | | | | 0 or 1 |
| Number of UL Samples in Range | | | | | | | | 0 or 1 |
| Range Start | | | | | | | | 0 or 1 |
| Range End | | | | | | | | 0 or 1 |
| Number of UL Samples in Range | | | | | | | | 0 or 1 |
| . . . | | | | | | | | 0 or (3*UL Delay |
| | | | | | | | | Range Number |
| | | | | | | | | Octet) |
| DL | DL | UL | New | New | New | New | New | 0 or 1 |
| Delay | Delay | Delay | IE | IE | IE | IE | IE | New IE |
| Dist | Dist | Dist | Flag | Flag 3 | Flag 2 | Flag 1 | Flag | Flags |
| Ind | for | Ind | 4 | | | | 0 | Octet |
| | E2E | | | | | | | |
| | Ind | | | | | | | |

Besides the usual PDU fields, the various latency/delay information fields in Table 4 are described in further detail below. Most of the field definitions of the UL/DL delay distribution information are similar to example implementation in relation to Table 3, except the following fields.

Specifically, for each of the DL latency ranges, a corresponding set of fields may be included to carry the distribution information for each DL latency range, including (1) a “Range Start” Field, which, if indicated as being present, may, for example, occupy 1 octet for indicating the start latency value of the corresponding DL latency range; (2) a “Range End” field, which, if indicated as being present, may, for example, occupy 1 octet for indicating the end latency value of the corresponding DL latency range; and (3) a “Number of DL Sample in Range” Field, which, for example, may occupy 1 octet for indicating the number of packets measured with the DL delay result within the value range indicated by the Range Start and Range End. As shown in Table 4, these three fields repeat in the PDU for the “DL Delay Distribution Range Number” of times.

Likewise, for each of the UL latency ranges, a corresponding set of fields may be included to carry the distribution information for each UL latency range, including (1) a “Range Start” Field, which, if indicated as being present, may, for example, occupy 1 octet for indicating the start latency value of the corresponding UL latency range; (2) a “Range End” field, which, if indicated as being present, may, for example, occupy 1 octet for indicating the end latency value of the corresponding UL latency range; and (3) a “Number of UL Sample in Range” Field, which, for example, may occupy 1 octet for indicating the number of packets measured with the UL delay result within the value range indicated by the Range Start and Range End. As shown in Table 4, these three fields repeat in the PDU for the “UL Delay Distribution Range Number” of times.

As an example, when the “Range Start” field is indicated as 0.2 and the “Range End” field is indicated as 0.4, the corresponding latency range may be (0.2 ms, 0.4 ms).

### UL PDU Session PDU for Reporting Latency Information Item Containing Packet Delay Samples

In some implementations, such special-purpose PDU may be constructed for reporting latency information items including latency distribution information related to latency packet-level samples as described above. An example construction of such PUD is illustrated below, which shows a UL PDU SESSION INFORMATION PDU (referred to as PDU Type 1) format with the UL/DL delay distribution information fields definition. Again, such a UL PDU SESSION INFORMATION PDU may be used to carry the UL/DL delay distribution information related to packet-level latency samples to UPF of the CN. It shall be further understood, other types of PDU(s) can also be constructed include similar fields to carry the UL/DL delay distribution information related to packet-level latency samples to a target network node.

TABLE 5

| Bits | | | | | | | | Number of |
|---|---|---|---|---|---|---|---|---|
| 7 | 6 | 5 | 4 | 3 | 2 | 1 | 0 | Octets |
| PDU Type (=1) | | | | QMP | DL | UL | SNP | 1 |
| | | | | | Delay | Delay | | |
| | | | | | Ind. | Ind. | | |
| N3/N9 | New | QoS Flow Identifier | | | | | | 1 |
| Delay | IE | | | | | | | |
| Ind. | Flag | | | | | | | |
| DL Sending Time Stamp Repeated | | | | | | | | 0 or 8 |
| DL Received Time Stamp | | | | | | | | 0 or 8 |
| UL Sending Time Stamp | | | | | | | | 0 or 8 |
| DL Delay Result | | | | | | | | 0 or 4 |
| UL Delay Result | | | | | | | | 0 or 4 |
| UL QFI Sequence Number | | | | | | | | 0 or 3 |
| N3/N9 Delay Result | | | | | | | | 0 or 4 |
| DL Delay Samples Number | | | | | | | | 0 or 1 |
| DL PDCP Sequence Number | | | | | | | | 0 or 4 |
| DL packet delay | | | | | | | | 0 or 4 |
| DL PDCP Sequence Number | | | | | | | | 0 or 4 |
| DL packet delay | | | | | | | | 0 or 4 |
| DL PDCP Sequence Number | | | | | | | | 0 or 4 |
| DL packet delay | | | | | | | | 0 or 4 |
| . . . | | | | | | | | 0 or (2*4*DL |
| | | | | | | | | Delay Samples |
| | | | | | | | | Number Octet) |
| UL Delay Samples Number | | | | | | | | 0 or 1 |
| UL PDCP Sequence Number | | | | | | | | 0 or 4 |
| UL packet delay | | | | | | | | 0 or 4 |
| UL PDCP Sequence Number | | | | | | | | 0 or 4 |
| UL packet delay | | | | | | | | 0 or 4 |
| UL PDCP Sequence Number | | | | | | | | 0 or 4 |
| UL packet delay | | | | | | | | 0 or 4 |
| . . . | | | | | | | | 0 or (2*4*UL |
| | | | | | | | | Delay Samples |
| | | | | | | | | Number Octet) |
| DL Delay | DL | UL | New | New | New | New | New | 0 or 1 |
| Samples | Delay | Delay | IE | IE | IE | IE | IE | New IE |
| Ind | for | Samples | Flag | Flag 3 | Flag 2 | Flag 1 | Flag | Flags |
| | E2E | Ind | 4 | | | | 0 | Octet |
| | Ind | | | | | | | |

Besides the usual PDU fields, the various latency/delay information fields in Table 5 are described in further detail below. Some of the field definitions of the UL/DL delay distribution information in Table 5 are similar to the above implementations in relation to Tables 3 and 4, except the following fields.

Specifically, a “DL Delay Sample Number” may be included. This parameter, if included, may, for example, occupy 1 octet for indicating up to 255 DL packet-level latency samples. This field may be followed by a corresponding number of blocks. Each block, if present, may occupy a number of octets (e.g., 4 octets) for carrying latency information of each DL packet, and further occupy a number of octets (e.g., 4 octets) for carrying the PDCP Sequence Number associated with the corresponding DL packet. Each of these blocks corresponds to one of the “DL packet delay” Fields and one of the “DL PDCP Sequence Number” Fields of Table 5.

Likewise, a “UL Delay Sample Number” may be included. This parameter, if included, may, for example, occupy 1 octet for indicating up to 255 UL packet-level latency samples. This field may be followed by a corresponding number of blocks. Each block, if present, may occupy a number of octets (e.g., 4 octets) for carrying latency information of each UL packet, and further occupy a number of octets (e.g., 4 octets) for carrying the PDCP Sequence Number associated with the corresponding UL packet. Each of these blocks corresponds to one of the “UL packet delay” Fields and one of the “UL PDCP Sequence Number” Fields of Table 5.

The per-packet latency information above, may be used by the various network node in the wireless network for calculating latency distribution information.

### UL PDU Session PDU for Reporting Latency Information Item Containing Latency Distribution Formula Information

In some implementations, such special-purpose PDU may be constructed for reporting latency information items including latency distribution information related to latency distribution formula as described above. An example construction of such PUD is illustrated below, which shows a UL PDU SESSION INFORMATION PDU (referred to as PDU Type 1) format with the UL/DL delay distribution formula information fields definition. Again, such a UL PDU SESSION INFORMATION PDU may be used to carry the UL/DL delay distribution formula information to UPF of the CN. It shall be further understood, other types of PDU(s) can also be constructed to include similar fields to carry the UL/DL delay distribution formula information to a target network node.

TABLE 6

| Bits | | | | | | | | Number of |
|---|---|---|---|---|---|---|---|---|
| 7 | 6 | 5 | 4 | 3 | 2 | 1 | 0 | Octets |
| PDU Type (=1) | | | | QMP | DL | UL | SNP | 1 |
| | | | | | Delay | Delay | | |
| | | | | | Ind. | Ind. | | |
| N3/N9 | New | QoS Flow Identifier | | | | | | 1 |
| Delay | IE | | | | | | | |
| Ind. | Flag | | | | | | | |
| DL Sending Time Stamp Repeated | | | | | | | | 0 or 8 |
| DL Received Time Stamp | | | | | | | | 0 or 8 |
| UL Sending Time Stamp | | | | | | | | 0 or 8 |
| DL Delay Result | | | | | | | | 0 or 4 |
| UL Delay Result | | | | | | | | 0 or 4 |
| UL QFI Sequence Number | | | | | | | | 0 or 3 |
| N3/N9 Delay Result | | | | | | | | 0 or 4 |
| DL Delay Distribution Formula ID | | | | | | | | 0 or 1 |
| Formula parameter Number for DL | | | | | | | | 0 or 1 |
| Formula parameter for DL | | | | | | | | 0 or 4 |
| Formula parameter for DL | | | | | | | | 0 or 4 |
| Formula parameter for DL | | | | | | | | 0 or 4 |
| . . . | | | | | | | | 0 or (4*DL |
| | | | | | | | | Formula |
| | | | | | | | | parameter |
| | | | | | | | | Number |
| | | | | | | | | Octet) |
| UL Delay Distribution Formula ID | | | | | | | | 0 or 1 |
| Formula parameter Number for UL | | | | | | | | 0 or 1 |
| Formula parameter for UL | | | | | | | | 0 or 4 |
| Formula parameter for UL | | | | | | | | 0 or 4 |
| Formula parameter for UL | | | | | | | | 0 or 4 |
| . . . | | | | | | | | 0 or (4*DL |
| | | | | | | | | Formula |
| | | | | | | | | parameter |
| | | | | | | | | Number |
| | | | | | | | | Octet) |
| DL | DL | UL | New | New | New | New | New | 0 or 1 |
| Delay | Delay | Delay | IE | IE | IE | IE | IE | New IE |
| Formula | for | Formula | Flag | Flag 3 | Flag 2 | Flag 1 | Flag | Flags |
| Ind | E2E | Ind | 4 | | | | 0 | Octet |
| | Ind | | | | | | | |

Besides the usual PDU fields, the various latency/delay information fields in Table 6 are described in further detail below. Some of the field definitions of the UL/DL delay distribution information in Table 6 are similar to the above implementations in relation to Tables 3, 4, and 5, except the following fields.

A “DL Delay Distribution Formula ID” Field may be included. This field, if present, may occupy, for example, 1 octet for indicating up to 255 DL latency distribution formula IDs corresponding to a set of predefined DL latency distribution formulae. For example, Formula ID=1 may correspond to a predefined Binomial distribution formula whereas Formula ID=2 may correspond to a predefined Normal distribution formula, etc.

A “Formula parameter Number for DL” Field may be included. This parameter, if present, may, for example, occupy 1 octet, for indicating up to 255 number of parameters used in the parameterized mathematical Distribution formula.

A block of “Formula parameter for DL” Fields may be included each for carrying one of the DL formula parameters. Each of these field, if present, may, for example, occupy 4 octets of specifying one DL formula parameter.

Likewise, a “UL Delay Distribution Formula ID” Field may be included. This field, if present, may occupy, for example, 1 octet for indicating up to 255 UL latency distribution formula IDs corresponding to a set of predefined UL latency distribution formulae. For example, Formula ID=1 may correspond to a predefined Binomial distribution formula whereas Formula ID=2 may correspond to a predefined Normal distribution formula, etc. A “Formula parameter Number for UL” Field may be included. This parameter, if present, may, for example, occupy 1 octet, for indicating up to 255 number of parameters used in the parameterized mathematical Distribution formula. A block of “Formula parameter for UL” Fields may be included each for carrying one of the UL formula parameters. Each of these field, if present, may, for example, occupy 4 octets of specifying one UL formula parameter.

As described above, a latency distribution formula may be a function that specifies all possible values for a latency variable and also quantifies the relative frequency (probability) of how often each particular latency variable value occur. In other words, a latency distribution formula provides a parameterized mathematical function that can be used to calculate the probability for any individual observation of latency from the sample space.

Example latency distribution formula may include but is not limited to Binomial distribution, Poisson distribution, Geometric distribution, Normal Distribution, and Lognormal distribution, etc. Latency distributions may be classified based on the type of data. For example, for the collected RAN part delay of the packets, or E2E delay of the packets between UPF and UE, the Normal Distribution may be suitable be used to describe the collected data, as show below.

TABLE 7

| Normal probability density formula | Components |
|---|---|
| $f ( x ) = \frac{1}{σ \sqrt{2 π}} {e}^{- \frac{{( x - μ )}^{2}}{2 {σ}^{2}}}$ | f(x) = probability x = value of the variable (delay/latency) μ = mean delay/latency |
| | σ = standard deviation |
| | σ² = variance |

In the case of the Normal probability density formula above is selected, the block(set) of UL delay distribution information in UL PDU SESSION PDU frame above can be assigned as following:
Delay Distribution Formula ID: ID=1 indicates the Normal probability density formula is used.
Formula parameter Number: equals=2 (only two parameters, μ and σ)
First item of the Formula parameter list: the value of μ, the first parameter.
Second item of the Formula parameter list: the value of σ, the second parameter.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method, by a wireless access network node of a wireless network, for provisioning a data transmission delay between a wireless terminal device and a core network, comprising:
receiving a transmission delay configuration from the core network, the transmission delay configuration specifying at least one of:
a transmission delay provisioning segmentation scheme among a plurality of segmentation schemes; or
a monitoring/reporting configuration for the data transmission delay among a plurality of monitoring/reporting configurations;
transmitting at least part of the transmission delay configuration to the wireless terminal device;
receiving a transmission delay information item from the wireless terminal device during a data transmission session between the core network and the wireless terminal device; and
generating and transmitting a report to the core network based on the transmission delay information item and according to the transmission delay configuration.

2. (canceled)

3. The method of claim 1, wherein the transmission delay provisioning segmentation scheme comprises one of an end-to-end delay scheme or a Radio Access Network (RAN) part delay scheme and the monitoring/reporting configuration comprises at least one of:
a reporting timing configuration;
a reporting granularity configuration; or
a data packet transmission timestamp scheme.

4. (canceled)

5. The method of claim 3, wherein the reporting timing configuration indicates a reporting frequency or reporting time period and the reporting granularity configuration indicates reporting the data transmission delay as at least one of:
an average data packet delay;
a per-packet delay;
a packet delay distribution; or
a packet delay distribution formula information.

6. The method of claim 5, wherein:
the reporting granularity configuration indicates reporting the data transmission delay as the packet delay distribution;
the packet delay distribution is included in an uplink protocol data unit (PDU) session frame; and
the uplink PDU session frame comprises:
a first field indicating a number of delay ranges; and
a plurality of blocks of fields, each block of fields comprises a number of packets with latency values falling into one of the delay ranges.

7. The method of claim 5, wherein:
the reporting granularity configuration indicates reporting the data transmission delay as the packet delay distribution formula information;
the packet delay distribution formula information is included in an uplink protocol data unit (PDU) session frame; and
the uplink PDU session frame comprises:
a first field for identifying a packet delay distribution formula;
a second field for indicating a number of parameters associated with the packet delay distribution formula; and
a block of fields comprising values of the number of parameters.

8. The method of claim 5, wherein:
the reporting granularity configuration indicates reporting the data transmission delay as the per-packet delay;
the per-packet delay is included in an uplink protocol data unit (PDU) session frame; and
the PDU session frame comprises:
a first field indicating a number of per-packet delay samples; and
a plurality of second fields each comprising a per-packet delay sample.

9.-11. (canceled)

12. The method of claim 3, wherein:
the data transmission delay comprises a downlink user-plane data transmission delay:
the method further comprises relaying at least one downlink data packets from the core network to the wireless terminal device; and
the transmission delay information item associated with the at least one downlink data packets is received from the wireless terminal device in a control-plane of the wireless access network node and comprises an end-to-end or RAN part downlink transmission delay information associated with the at least one downlink data packets as calculated by the wireless terminal device.

13. (canceled)

14. The method of claim 12, wherein generating and transmitting the report to the core network comprises:
inserting the report in an NG Application Protocol (NGAP) message and transmitting the NGAP message to the core network in the control-plane; or
inserting the report into an E1 Application Protocol (E1AP) message in the control-plane and transmitting the E1AP message to a user-plane of the wireless access network node, extracting the report from the E1AP message and inserting the report into a PDU session information PDU in the user-plane of the wireless access network node, and transmitting the PDU session information PDU to the core network in the user-plane.

15. (canceled)

16. (canceled)

17. The method of claim 3, wherein the data transmission delay comprises an uplink user-plane data transmission delay and the transmission delay information item received from the wireless terminal device comprises timestamp information for at least one uplink data packet transmitted from the wireless terminal device.

18. (canceled)

19. The method of claim 17, wherein:
the transmission delay provisioning segmentation scheme comprises the end-to-end delay scheme; and
generating and transmitting the report to the core network according to the transmission delay configuration comprises relaying the timestamp information to the core network for the core network to calculate the data transmission delay.

20. The method of claim 17, wherein:
the transmission delay provisioning segmentation scheme comprises the RAN part delay scheme; and
generating and transmitting the report to the core network according to the transmission delay configuration comprises:
calculating a RAN part delay information associated with the at least one uplink data packet in a user-plane of the wireless access network node, transmitting the RAN part delay information to a control-plane of the wireless access network node, and transmitting the RAN part delay information to the core network via an NGAP message in the control-plane; or
calculating a RAN part delay information associated with the at least one uplink data packet in the user-plane of the wireless access network node, and transmitting the RAN part delay information to the core network via an uplink PDU session information PDU to the core network in the user-plane.

21. (canceled)

22. A method, by a wireless terminal device, for monitoring/reporting a data transmission delay between the wireless terminal device and a core network in a wireless network, comprising:
receiving a transmission delay configuration from control-plane of a wireless access network node, the transmission delay configuration specifying at least one of:
a transmission delay provisioning segmentation scheme among a plurality of segmentation schemes; or
a monitoring/reporting configuration for the data transmission delay among a plurality of monitoring/reporting configurations; and
transmitting a transmission delay information item to the wireless access network node during a data transmission session between the core network and the wireless terminal device according to the transmission delay configuration.

23. (canceled)

24. The method of claim 22, wherein the data transmission delay provisioning segmentation scheme comprises one of an end-to-end delay scheme or a Radio Access Network (RAN) part delay scheme and the monitoring/reporting configuration comprises at least one of:
a reporting timing configuration;
a reporting granularity configuration; or
a data packet transmission timestamp scheme.

25. (canceled)

26. The method of claim 24, wherein the reporting granularity configuration indicates reporting the data transmission delay as at least one of:
an average data packet delay;
a per-packet delay;
a packet delay distribution; or
a packet delay distribution formula information.

27. The method of claim 26, wherein:
the reporting granularity configuration indicates reporting the data transmission delay as the packet delay distribution;
the packet delay distribution is included in an uplink protocol data unit (PDU) session frame; and
the uplink PDU session frame comprises:
a first field indicating a number of delay ranges, and a plurality of blocks of fields, each block of fields comprises a number of packets with delay values falling into one of the delay ranges; or
a first field for identifying a packet delay distribution formula, a second field for indicating a number of parameters associated with the packet delay distribution formula, and a block of fields comprising values of the number of parameters.

28. (canceled)

29. The method of claim 26, wherein:
the reporting granularity configuration indicates reporting the data transmission delay as the per-packet delay;
the per-packet delay is included in an uplink protocol data unit (PDU) session frame; and
the uplink PDU session frame comprises:
a first field indicating a number of per-packet delay samples; and
a plurality of second fields each comprising a per-packet delay sample.

30. The method of claim 24, wherein the data packet transmission timestamp scheme indicates one of:
including transmission time stamps in data packet headers; or
including transmission timestamps in packet data converged protocol headers.

31. (canceled)

32. (canceled)

33. The method of claim 22, wherein:
the data transmission delay comprises a downlink user-plane data transmission delay;
the method comprises obtaining receive-timestamp information for at least one downlink data packet and generating the transmission delay information item by calculating an end-to-end or RAN part downlink transmission delay information associated with the at least one downlink data packets according to the receive-timestamp information and the transmission delay configuration; and
the transmission delay information item is transmitted to a control-plane of the wireless access network node.

34.-56. (canceled)

57. A wireless network node, comprising a memory for storing instructions and a processor for executing the instructions to implement claim 1.

58. (canceled)

59. A wireless terminal device, comprising a memory for storing instructions and a processor for executing the instructions to:
receive a transmission delay configuration from control-plane of a wireless access network node, the transmission delay configuration specifying at least one of:
a transmission delay provisioning segmentation scheme among a plurality of segmentation schemes; or
a monitoring/reporting configuration for a data transmission delay among a plurality of monitoring/reporting configurations; and
transmit a transmission delay information item to the wireless access network node during a data transmission session between a core network and the wireless terminal device according to the transmission delay configuration.
